(19) United States
(12) Patent Application Publication
(10) Pub. No.: US 2026/0312070 A1
(43) Pub. Date: Oct. 8, 2026

(54) SECONDARY BATTERY

(71) Applicant: SEMICONDUCTOR ENERGY LABORATORY CO., LTD., Atsugi-shi (JP)

(72) Inventors: Jo SAITO, Atsugi (JP); Yohei MOMMA, Isehara (JP); Kunihiro FUKUSHIMA, Isehara (JP); Teppei OGUNI, Atsugi (JP)

(21) Appl. No.: 19/714,860

(22) Filed: Jun. 22, 2026

Related U.S. Application Data
(63) Continuation of application No. 18/360,024, filed on Jul. 27, 2023, now abandoned.

(30) Foreign Application Priority Data
Jul. 29, 2022 (JP) 2022-121785

(51) Int. Cl. H01M 4/62; H01M 4/02; H01M 4/1315; H01M 4/134; H01M 4/525; H01M 10/052

(52) U.S. Cl. CPC H01M 4/628; H01M 4/1315; H01M 4/134; H01M 4/525; H01M 2004/028; H01M 10/052

(57) ABSTRACT

A secondary battery with little deterioration is provided. A highly reliable secondary battery is provided. A positive electrode active material included in the secondary battery includes a crystal of lithium cobalt oxide. The positive electrode active material includes a first region including a surface parallel to the (001) plane of the crystal and a second region including a surface parallel to a plane intersecting with the (001) plane. The positive electrode active material contains magnesium. The first region includes a portion with a magnesium concentration that is higher than or equal to 0.5 atomic % and lower than or equal to 10 atomic %. The second region includes a portion with a magnesium concentration that is higher than the magnesium concentration in the first region and is higher than or equal to 4 atomic % and lower than or equal to 30 atomic %. Furthermore, the second region includes a portion with a fluorine concentration that is higher than a fluorine concentration in the first region and is higher than or equal to 0.5 atomic % and lower than or equal to 10 atomic %.

### CROSS-REFERENCE TO RELATED APPLICATIONS

This application is a continuation of U.S. application Ser. No. 18/360,024, filed Jul. 27, 2023, now allowed, which is incorporated by reference, and claims the benefit of a foreign priority application filed in Japan as Serial No. 2022-121785 on Jul. 29, 2022.

### BACKGROUND OF THE INVENTION

### 1. Field of the Invention

One embodiment of the present invention relates to a battery. One embodiment of the present invention relates to a secondary battery. One embodiment of the present invention relates to a positive electrode material of a battery.

Note that one embodiment of the present invention is not limited to the above technical field. One embodiment of the present invention relates to a power storage device including a secondary battery, a semiconductor device, a display device, a light-emitting device, a lighting device, an electronic device, or a manufacturing method thereof. A semiconductor device generally means a device that can function by utilizing semiconductor characteristics.

### 2. Description of the Related Art

In recent years, a variety of storage batteries such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, lithium-ion secondary batteries for mobile electronic devices are highly required to have high discharge capacity per weight and excellent cycle performance. Thus, positive electrode active materials contained in positive electrodes of lithium-ion secondary batteries have been actively improved (see Patent Documents 1 to 4 and Non-Patent Documents 1 to 4, for example).

### REFERENCE

### Patent Documents

[Patent Document 1] Japanese Published Patent Application No. 2019-179758
[Patent Document 2] PCT International Publication No. WO2020/026078
[Patent Document 3] Japanese Published Patent Application No. 2020-140954
[Patent Document 4] Japanese Published Patent Application No. 2019-129009

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2]T. Motohashi et al., “Electronic phase diagram of the layered cobalt oxide system LiₓCoO₂ (0.0≤x×1.0)”, Physical Review B, 80 (16); 165114.
[Non-Patent Document 3] Zhaohui Chen et al., “Staging Phase Transitions in LiₓCoO₂”, Journal of The Electrochemical Society, 2002, 149 (12), A1604-A1609.
[Non-Patent Document 4]G. G. Amatucci et al., “CoO₂, The End Member of the LiₓCoO₂ Solid Solution”, J. Electrochem. Soc., 143 (3), 1114 (1996).
[Non-Patent Document 5]K. Momma and F. Izumi, “VESTA 3 for three-dimensional visualization of crystal, volumetric and morphology data” J. Appl. Cryst. (2011). 44, 1272-1276.
[Non-Patent Document 6]A. Belsky et al., “New developments in the Inorganic Crystal Structure Database (ICSD): accessibility in support of materials research and design”, Acta Cryst., (2002), B58, 364-369.

### SUMMARY OF THE INVENTION

An object of one embodiment of the present invention is to provide a secondary battery with little deterioration. Another object of one embodiment of the present invention is to provide a highly reliable secondary battery. Another object of one embodiment of the present invention is to provide a secondary battery in which a decrease in discharge capacity in charge and discharge cycles is inhibited. Another object of one embodiment of the present invention is to provide a secondary battery with a high degree of safety.

Note that the description of these objects does not preclude the existence of other objects. In one embodiment of the present invention, there is no need to achieve all these objects. Objects other than these can be derived from the description of the specification, the drawings, the claims, and the like.

One embodiment of the present invention is a secondary battery including a positive electrode containing a positive electrode active material. The positive electrode active material includes a crystal of lithium cobalt oxide. The positive electrode active material includes a first region including a surface parallel to the (001) plane of the crystal and a second region including a surface parallel to a plane intersecting with the (001) plane. The positive electrode active material contains magnesium. The first region includes a portion with a magnesium concentration that is higher than or equal to 0.5 atomic % and lower than or equal to 10 atomic %.

The second region includes a portion with a magnesium concentration that is higher than the magnesium concentration in the first region and is higher than or equal to 4 atomic % and lower than or equal to 30 atomic %.

In the above, the positive electrode active material preferably contains fluorine. In this case, the second region preferably includes a portion with a fluorine concentration that is higher than a fluorine concentration in the first region and is higher than or equal to 0.5 atomic % and lower than or equal to 10 atomic %.

In the above, the first region preferably includes a portion with a fluorine concentration that is lower than 0.5 atomic % in analysis by electron energy loss spectroscopy.

In the above, in the second region, a portion closer to the surface preferably has a higher fluorine concentration in analysis by electron energy loss spectroscopy.

In the above, the positive electrode active material preferably contains nickel. In this case, the second region preferably includes a portion with a nickel concentration that is higher than a nickel concentration in the first region and is higher than or equal to 0.5 atomic % and lower than or equal to 10 atomic %.

In the above, the positive electrode active material preferably contains aluminum. In this case, it is preferably that each of the first region and the second region independently include a portion with an aluminum concentration that is higher than or equal to 0.5 atomic % and lower than or equal to 10 atomic %. Furthermore, the difference in the aluminum concentration between the portions of the first region and the second region is preferably larger than or equal to 0 atomic % and smaller than or equal to 7 atomic %.

According to one embodiment of the present invention, a secondary battery with little deterioration can be provided. Alternatively, a highly reliable secondary battery can be provided.

Alternatively, a secondary battery in which a decrease in discharge capacity in charge and discharge cycles is inhibited can be provided. Alternatively, a secondary battery with a high degree of safety can be provided.

Note that the description of these effects does not preclude the existence of other effects. One embodiment of the present invention does not necessarily have all these effects.

Effects other than these can be derived from the description of the specification, the drawings, the claims, and the like.

### BRIEF DESCRIPTION OF THE DRAWINGS

In the accompanying drawings:

FIGS. 1A to 1C show a structure example of a positive electrode active material;

FIGS. 2A to 2D show structure examples of a positive electrode active material;

FIGS. 3A and 3B show structure examples of a positive electrode active material;

FIG. 4 shows a structure example of a positive electrode active material;

FIG. 5 shows a structure example of a positive electrode active material;

FIG. 6 is an example of a TEM image of a crystal;

FIG. 7A is an example of a STEM image and FIGS. 7B and 7C are examples of FFT patterns;

FIG. 8 shows XRD patterns;

FIG. 9 shows XRD patterns;

FIGS. 10A and 10B show XRD patterns;

FIGS. 11A to 11C are graphs showing lattice constants;

FIG. 12 shows a structure example of a positive electrode active material;

FIGS. 13A to 13C show methods for forming a positive electrode active material;

FIGS. 14A to 14C show methods for forming a positive electrode active material;

FIG. 15 shows a method for forming a positive electrode active material;

FIGS. 16A to 16C show methods for forming a positive electrode active material;

FIG. 17 illustrates a heating furnace and a heating method;

FIGS. 18A to 18D illustrate structure examples of electronic devices;

FIGS. 19A to 19C illustrate structure examples of electronic devices;

FIGS. 20A to 20C illustrate structure examples of vehicles;

FIGS. 21A and 21B show STEM-EDX measurement results;

FIGS. 22A and 22B show STEM-EELS measurement results;

FIGS. 23A and 23B show STEM-EELS measurement results; and

FIGS. 24A to 24D show calculation results in Example 2.

### DETAILED DESCRIPTION OF THE INVENTION

Embodiments will be described below with reference to the drawings. Note that the embodiments can be implemented with many different modes, and it will be readily understood by those skilled in the art that modes and details thereof can be changed in various ways without departing from the spirit and scope thereof. Therefore, the present invention should not be construed as being limited to the description of embodiments below.

Note that in structures of the invention described below, the same portions or portions having similar functions are denoted by the same reference numerals in different drawings, and the description thereof is not repeated. The same hatching pattern is used for portions having similar functions, and the portions are not especially denoted by reference numerals in some cases.

Note that in each drawing described in this specification, the size, the layer thickness, or the region of each component is exaggerated for clarity in some cases. Therefore, the size, the layer thickness, or the region is not limited to the illustrated scale.

Note that in this specification and the like, ordinal numbers such as “first” and “second” are used in order to avoid confusion among components and do not limit the number of components.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material refers to the amount of electricity obtained when all lithium ions that can be inserted into and extracted from the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium ions that can be inserted into and extracted from a positive electrode active material is represented by x in a compositional formula, e.g., LiₓCoO₂.

In the case of a positive electrode active material in a lithium-ion secondary battery, x can be represented by (theoretical capacity−charge capacity)/theoretical capacity. For example, when a lithium-ion secondary battery using LiCoO₂ as a positive electrode active material is charged to 219.2 mAh/g, the positive electrode active material can be represented by Li_{0.2}CoO₂, i.e., x=0.2. Note that “x in LiₓCoO₂ is small” means, for example, 0.1<x≤0.24.

Lithium cobalt oxide to be used for a positive electrode, which has been appropriately synthesized and almost satisfies the stoichiometric proportion, has a composition of LiCoO₂ with x of 1. It can also be said that lithium cobalt oxide in a lithium-ion secondary battery after its discharging ends has a composition of LiCoO₂ with x of 1. Here, “discharging ends” means that the voltage becomes 3.0 V or 2.5 V or lower at a current of 100 mA/g or lower, for example.

Charge capacity and/or discharge capacity used for calculation of x in LiₓCoO₂ is preferably measured under the condition where there is no influence or small influence of a short circuit and/or decomposition of an electrolyte solution or the like. For example, data of a lithium-ion secondary battery, containing a sudden change in capacity that seems to result from a short circuit should not be used for calculation of x.

The space group of a crystalline material included in a lithium-ion secondary battery is identified by X-ray diffraction (XRD), electron diffraction, neutron diffraction, or the like. Thus, in this specification and the like, “belonging to a space group” or “being a space group” can be rephrased as being identified as a space group.

A structure is referred to as a cubic close-packed structure when three layers of anions are shifted and stacked like “ABCABC” in the structure. Accordingly, anions do not necessarily form a cubic lattice structure. In addition, actual crystals always have defects and thus analysis results are not always consistent with the theory. For example, in an electron diffraction pattern or a fast Fourier transform (FFT) pattern of a TEM image or the like, a spot may appear in a position slightly different from a theoretical position. For example, anions may be regarded as forming a cubic close-packed structure when the difference in orientation from a theoretical position is 5° or less or 2.5° or less.

The distribution of an element indicates the region where the element is successively detected at a level higher than the background noise by a spatially successive analysis method.

A positive electrode active material to which an additive element is added is sometimes referred to as a composite oxide, a positive electrode member, a positive electrode material, a lithium-ion secondary battery positive electrode member, or the like. A positive electrode active material of one embodiment of the present invention preferably contains one or more of a compound, a composition, and a complex.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a lithium-ion secondary battery including the positive electrode active material is sufficiently obtained.

An internal short circuit and an external short circuit of a lithium-ion secondary battery might cause not only a malfunction in charge operation and/or discharge operation of the lithium-ion secondary battery but also heat generation and ignition. Thus, in order to obtain a safe lithium-ion secondary battery, an internal short circuit and an external short circuit are preferably inhibited even at a high charge voltage. With the positive electrode active material of one embodiment of the present invention, an internal short circuit is inhibited even at a high charge voltage. Thus, a lithium-ion secondary battery with both high discharge capacity and a high degree of safety can be obtained. Note that an internal short circuit of a lithium-ion secondary battery refers to contact between a positive electrode and a negative electrode in the battery. An external short circuit of a lithium-ion secondary battery refers to contact between a positive electrode and a negative electrode outside the battery on the assumption that the battery is misused.

Note that the description is made on the assumption that materials (such as a positive electrode active material, a negative electrode active material, an electrolyte solution, and a separator) of a lithium-ion secondary battery have not been degraded unless otherwise specified.

A decrease in discharge capacity due to aging treatment and burn-in treatment during the manufacturing process of a lithium-ion secondary battery is not regarded as degradation. For example, a state where discharge capacity is higher than or equal to 97% of the rated capacity of a lithium-ion secondary battery composed of a cell or an assembled battery can be regarded as a non-degraded state. The rated capacity conforms to Japanese Industrial Standards (JIS C 8711:2019) in the case of a lithium-ion secondary battery for a portable device. The rated capacities of other lithium-ion secondary batteries conform to JIS described above, JIS for electric vehicle propulsion, industrial use, and the like, standards defined by the International Electrotechnical Commission (IEC), and the like.

In this specification and the like, in some cases, materials included in a lithium-ion secondary battery that have not been degraded are referred to as initial products or materials in an initial state, and materials that have been degraded (have discharge capacity lower than 97% of the rated capacity of the lithium-ion secondary battery) are referred to as products in use, materials in a used state, products that are already used, or materials in an already-used state.

In this specification and the like, a lithium-ion secondary battery refers to a battery in which lithium ions are used as carrier ions; however, carrier ions in the present invention are not limited to lithium ions. For example, as the carrier ion in the present invention, alkali metal ions or alkaline earth metal ions (specifically, sodium ions or the like) can be used. In that case, the present invention can be understood by replacing lithium ions with sodium ions or the like. In the case where there is no limitation on carrier ions, a simple term “secondary battery” is sometimes used.

### Embodiment 1

In this embodiment, a structure example of a positive electrode active material that can be used for a positive electrode of a secondary battery of one embodiment of the present invention and an example of a method for manufacturing the positive electrode active material are described.

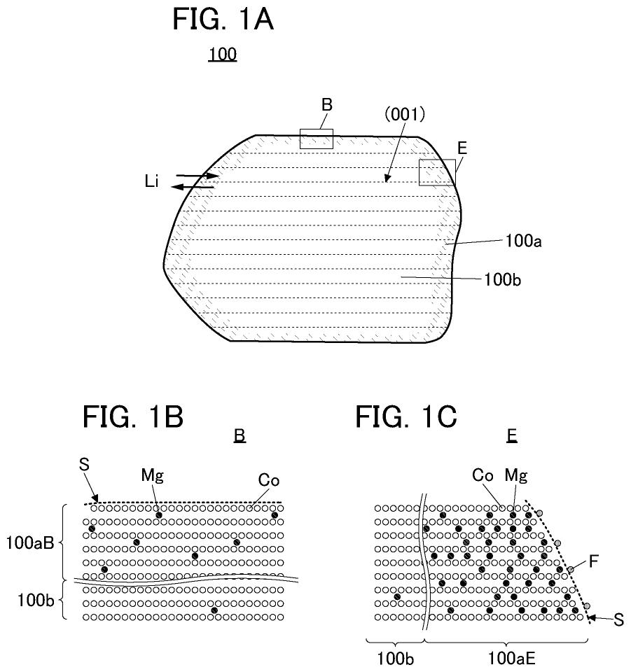

FIG. 1A is a cross-sectional schematic view of a positive electrode active material 100 of one embodiment of the present invention. The positive electrode active material 100 includes a surface portion 100a and an inner portion 100b. In FIG. 1A, the surface portion 100a is hatched.

The surface portion 100a of the positive electrode active material 100 refers to a region within 50 nm, preferably within 35 nm, further preferably within 20 nm, still further preferably within 10 nm in depth from the surface toward the inner portion. The surface portion 100a includes the surface. Here, a plane generated by a crack or the like can be considered as a surface. The surface portion 100a can also be referred to as the vicinity of a surface, a region in the vicinity of a surface, a shell, or the like.

A region of the positive electrode active material 100 deeper than the surface portion 100a is referred to as the inner portion 100b. The inner portion 100b can also be referred to as an inner region, a bulk, a core, or the like.

The positive electrode active material 100 contains cobalt, lithium, oxygen, and an additive element. The positive electrode active material 100 can be regarded as lithium cobalt oxide to which an additive element is added.

Cobalt contained in the positive electrode active material 100 is a transition element that can undergo oxidation and reduction, and has a function of maintaining a neutrally charged state of the positive electrode active material 100 even when lithium ions are inserted and extracted. Note that at least one of nickel and manganese may be contained in addition to cobalt. Using cobalt at higher than or equal to 75 atomic %, preferably higher than or equal to 90 atomic %, further preferably higher than or equal to 95 atomic % as the transition metal contained in the positive electrode active material 100 brings many advantages such as relatively easy synthesis, easy handling, and excellent cycle performance, which is preferable. This is probably because a higher content of cobalt minimizes the effect of distortion due to the Jahn-Teller effect when lithium ions are extracted, and thus the stability of the crystal is increased.

The positive electrode active material 100 further contains magnesium (Mg) as the additive element. In the positive electrode active material 100 of one embodiment of the present invention, magnesium is present in the surface portion 100a at a higher concentration than in the inner portion 100b.

The positive electrode active material 100 display cleavage parallel to the (001) plane. FIG. 1A schematically shows the (001) plane that is one of planes parallel to the (001) plane with dotted lines. A region B in FIG. 1A is a region including a surface parallel to the (001) plane. That is, the surface of the positive electrode active material 100 in the region B is parallel to the basal plane. In contrast, a region E in FIG. 1A is a region including a surface that is not parallel to the (001) plane that is one of the basal planes. The surface of the positive electrode active material 100 in the region E is referred to as an edge plane. The edge plane can also be referred to as a surface parallel to a plane intersecting with the (001) plane.

FIG. 1B is an enlarged schematic view of the region B, and FIG. 1C is an enlarged schematic view of the region E. In FIG. 1B, a surface portion 100aB in the vicinity of the surface parallel to the basal plane in the surface portion 100a and the inner portion 100b are shown. In FIG. 1C, a surface portion 100aE in the vicinity of the edge plane and the inner portion 100b are shown. In each of FIGS. 1B and 1C, a surface S of the positive electrode active material 100 is indicated by a dotted line. In each of FIGS. 1B and 1C, elements are indicated by circles with different hatching patterns to be distinguished from each other. Note that oxygen (O) atoms and lithium (Li) atoms are not shown in FIGS. 1B and 1C.

The surface S in FIG. 1B is a plane parallel to the basal plane. FIG. 1B illustrates the state in which cobalt (Co) atoms are periodically arranged parallel to the surface S in the surface portion 100aB and the inner portion 100b. A layer of Co two-dimensionally arranged parallel to the surface S is referred to as a Co layer. In FIG. 1B, magnesium (Mg) atoms are positioned between two adjacent Co layers. In the vicinity of the surface parallel to the basal plane, Mg is contained more in the surface portion 100aB than in the inner portion 100b. Mg tends to be mainly positioned at lithium sites in a crystal structure of lithium cobalt oxide. Note that Mg may be positioned at some of Co sites.

When Mg completely covers the entire surface portion, one or both of electron conduction and insertion and extraction of lithium ions are hindered, which makes it difficult to obtain preferable battery characteristics in a charge and discharge test. Moreover, when Mg is present in the inner portion 100b at a higher concentration than in the surface portion 100a, the discharge capacity might be reduced. In contrast, Mg is preferably present in the surface portion 100a at an appropriate concentration because lithium cobalt oxide can be stabilized and heat generation and smoking can be inhibited in a nail penetration test or the like, for example. Furthermore, the hardness of lithium cobalt oxide can be expected to be increased.

The surface S in FIG. 1C corresponds to the edge plane. That is, the surface S in FIG. 1C is a plane through which lithium ions are inserted and extracted in charging and discharging and which is positioned at end portions of the Co layers. As illustrated in FIG. 1C, a larger amount of Mg is contained in the surface portion 100aE in the vicinity of the edge plane than in the surface portion 100aB in the vicinity of the surface parallel to the basal plane. This is probably due to the following reason: the basal plane is a cleavage plane and includes more stable bonds than a crystal plane perpendicular to the basal plane. Thus, the additive element is difficult to diffuse perpendicularly to the basal plane. In contrast, the edge plane is a relatively unstable plane including many defects, and thus the additive element is easy to diffuse to an inner portion.

That is, in the positive electrode active material 100, a larger amount of Mg is present in the surface portion 100a than in the inner portion 100b. Furthermore, a larger amount of Mg is present in the surface portion 100aE in the vicinity of the edge plane than in the surface portion 100aB in the vicinity of the surface parallel to the basal plane. The surface portion 100aB in the vicinity of the surface parallel to the basal plane includes a region where the Mg concentration is higher than or equal to 0.5 atomic % and lower than or equal to 10 atomic %, preferably higher than or equal to 1 atomic % and lower than or equal to 7 atomic %, further preferably higher than or equal to 1.5 atomic % and lower than or equal to 6 atomic %. In contrast, the surface portion 100aE in the edge plane includes a region where the Mg concentration is higher than at least that in the surface portion 100aB and is higher than or equal to 4 atomic % and lower than or equal to 30 atomic %, preferably higher than or equal to 5 atomic % and lower than or equal to 20 atomic %, further preferably higher than or equal to 6 atomic % and lower than or equal to 15 atomic %. When Mg is present at such appropriate concentrations both in the surface portion 100aB and in the surface portion 100aE, cycle deterioration of the positive electrode active material 100 can be reduced.

The positive electrode active material 100 may contain fluorine (F) as the additive element. It is known that F has high electronegativity and is likely to form stable compounds with many kinds of elements. The positive electrode active material 100 is soaked in an electrolyte solution in a secondary battery; thus, the interface between the positive electrode active material 100 and the electrolyte solution can be stabilized by F adsorbing onto the surface of the positive electrode active material 100 or being present in the immediate vicinity of the surface. The interface can be stabilized in the case where the reaction between the surface of the positive electrode active material 100 and the electrolyte solution is suppressed and in the case where a favorable coating film made of a decomposition product of the electrolyte solution is formed on the surface of the positive electrode active material 100.

In the case where the positive electrode active material 100 contains F as the additive element, F is hardly observed in the inner portion 100b and a region distant from the surface of the surface portion 100a, and is included in the immediate vicinity of the surface S of the surface portion 100a or is present to attach or adsorb onto the surface S as in FIG. 1C. As illustrated in FIG. 1B, fluorine is hardly observed in the surface that is parallel to the basal plane and stable.

That is, in the positive electrode active material 100, F is hardly observed in the inner portion 100b and the surface portion 100aB in the vicinity of the surface parallel to the basal plane and observed in a region very close to the surface S of the surface portion 100aE in the vicinity of the edge plane. For example, the F concentration in the surface portion 100aE in the edge plane is preferably higher than or equal to 0.5 atomic % and lower than or equal to 10 atomic %, further preferably higher than or equal to 1 atomic % and lower than or equal to 8 atomic %, still further preferably higher than or equal to 2 atomic % and lower than or equal to 7 atomic %. When F is present in the surface of the surface portion 100aE at such an appropriate concentration, lithium ions can be much easily inserted and extracted.

The positive electrode active material 100 may contain nickel (Ni) as the additive element. In some cases, Ni is present not only in the surface portion 100a but also in the inner portion 100b of lithium cobalt oxide. Even when Ni is present in the inner portion of lithium cobalt oxide, Ni has a function of compensating for electric charge via a redox reaction and thus the discharge capacity of the positive electrode active material 100 is less likely to be reduced. Thus, lithium cobalt oxide containing Ni in the inner portion 100b can maintain high charge and discharge capacity. Moreover, the crystal structure of lithium cobalt oxide containing Ni in the inner portion 100b is less likely to be broken even when high-voltage charge is performed.

Mg as well as Ni in the positive electrode active material 100 has a function of stabilizing the crystal structure of lithium cobalt oxide and making the crystal structure less likely to be broken.

For example, oxygen is less likely to be released from lithium cobalt oxide when the crystal structure is less likely to be broken. Oxygen released from the positive electrode active material 100 promotes combustion when an inner short circuit or the like occurs in a secondary battery, and thus is one factor of thermal runaway. In view of the above, a secondary battery that is less likely to cause thermal runaway even when an inner short circuit occurs can be provided with the positive electrode active material 100 that is less likely to release oxygen.

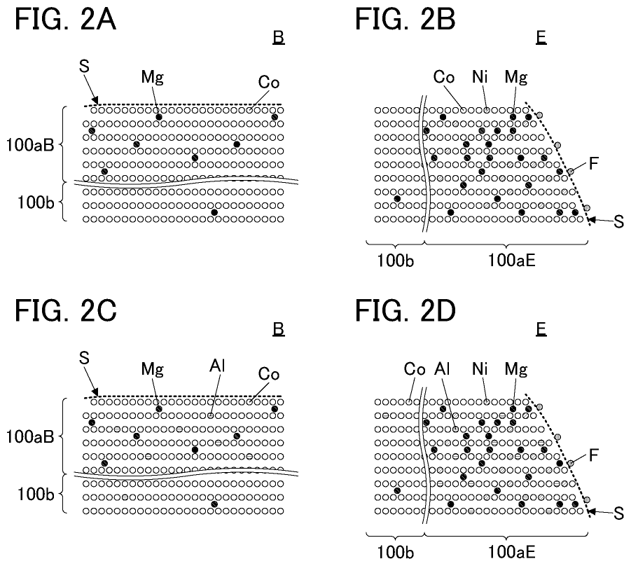

FIGS. 2A and 2B illustrate cross sections in the vicinity of the surface parallel to the basal plane and in the vicinity of the edge plane when nickel (Ni) is used as another additive element. Little of Ni is contained in the inner portion 100b and most of Ni is contained in the surface portion 100a in some cases. In addition, a large amount of Ni is contained in the surface portion 100aE in the vicinity of the edge plane and Ni is hardly observed in the surface portion 100aB in the vicinity of the surface parallel to the basal plane. That is, it can also be said that Ni is not easily diffused from the surface parallel to the basal plane and is easily diffused from the edge plane. Ni can be present at either of a Co side and a Li site of lithium cobalt oxide. FIG. 2B illustrates an example in which Ni is present at Co sites.

That is, in the positive electrode active material 100, Ni is hardly observed in the inner portion 100b and the surface portion 100aB in the vicinity of the surface parallel to the basal plane, and a large amount of Ni is present in the surface portion 100aE in the vicinity of the edge plane. The Ni concentration in the surface portion 100aE in the edge plane is preferably higher than or equal to 0.5 atomic % and lower than or equal to 10 atomic %, further preferably higher than or equal to 0.3 atomic % and lower than or equal to 7 atomic %, still further preferably higher than or equal to 0.5 atomic % and lower than or equal to 5 atomic %. When Ni, which has a lower redox potential than Co, is present in the surface portion 100aE at such an appropriate concentration, the capacity can be increased with the same charge voltage as compared to the case where Ni is not present.

FIGS. 2C and 2D illustrate cross sections in the vicinity of the surface parallel to the basal plane and in the vicinity of the edge plane when aluminum (Al) is contained as another additive element. Although Al is contained both in the inner portion 100b and in the surface portion 100a, Al is observed more in the surface portion 100a than in the inner portion 100b. Furthermore, Al is contained to be distributed to both the vicinity of the edge plane and the vicinity of the surface parallel to the basal plane. In addition, Al tends to be present at Co sites of lithium cobalt oxide.

That is, a larger amount of Al is present in the surface portion 100a than in the inner portion 100b in the positive electrode active material 100. Furthermore, Al is present both in the surface portion 100aB in the vicinity of the surface parallel to the basal plane and in the surface portion 100aE in the vicinity of the edge plane. The Al concentration in each of the surface portion 100aB in the vicinity of the surface parallel to the basal plane and the surface portion 100aE in the edge plane is independently preferably higher than or equal to 0.5 atomic % and lower than or equal to 10 atomic %, further preferably higher than or equal to 0.5 atomic % and lower than or equal to 8 atomic %, still further preferably higher than or equal to 0.8 atomic % and lower than or equal to 5 atomic %. In addition, the difference in the Al concentration between the surface portion 100aB and the surface portion 100aE is preferably smaller. For example, the difference is preferably larger than or equal to 0 atomic % and smaller than or equal to 7 atomic %, further preferably larger than or equal to 0 atomic % and smaller than or equal to 5 atomic %, still further preferably larger than or equal to 0 atomic % and smaller than or equal to 3 atomic %. When Al is present in the surface portion 100a at such an appropriate concentration, robustness of the crystal structure in repeated charging and discharging can be increased and cycle deterioration can be reduced while a decrease in the capacity is minimized. Furthermore, as described above, Al is preferably distributed uniformly in the vicinity of the basal plane and in the vicinity of the edge plane because uneven distribution of Al concentration in the surface portion 100a might promote breakage of a crystal in a portion that has a locally low Al concentration and is easily broken.

The concentration distribution of each additive element from the surface S to the surface portion 100a and the inner portion 100b in the positive electrode active material 100 can be analyzed by a method such as energy dispersive X-ray spectroscopy (EDX), electron energy-loss spectroscopy (EELS), or the like. Without being limited to the above methods, X-ray photoelectron spectroscopy (XPS), electron probe micro analysis (EPMA), or the like can also be used for the analysis.

In particular, a combined analysis apparatus in which an EDX analyzer or an EELS analyzer is attached to a transmission electron microscope (TEM) or a scanning TEM (STEM) is preferably used. With such an apparatus, a measurement point of EDX or EELS can be determined in a cross-sectional observation image taken with a TEM (or a STEM) and in-situ EDX analysis or in-situ EELS analysis can be performed. Such an analysis method can be referred to as a TEM (or STEM)-EDX method or a TEM (or STEM)-EELS method.

Although the lower detection limit of EDX is approximately 1 atomic %, it may be increased depending on measurement condition, an element to be measured, and the like. Although the lower detection limit of EELS is approximately 0.5 atomic %, it may be increased depending on measurement condition, an element to be measured, and the like.

Mg, Ni, and Al of the above additive elements are preferably measured by an EDX method. In contrast, since the energy of the characteristic X-ray of F is extremely close to that of Co, F is difficult to analyze with high accuracy by an EDX method and thus is preferably measured by an EELS method which has a higher energy resolution than an EDX method.

Lithium cobalt oxide containing one or more of the above additive elements is preferably used for the positive electrode active material 100. The additive element has a function of stabilizing the positive electrode active material 100 more, and thus release of oxygen from lithium cobalt oxide can be inhibited, improving thermal stability. Specifically, when lithium cobalt oxide containing Mg is used for the positive electrode active material 100, the crystal structure can be stabilized, oxygen release can be inhibited, and the thermal stability can be increased. Furthermore, an insulating property can be improved and thus thermal runaway can be inhibited. The use of F as the additive element inhibits release of oxygen from the edge plane, improves the thermal stability, and inhibits thermal runaway.

Here, in crystallography, a general way of choosing a unit cell formed with three axes (crystal axes) of the a-axis, the b-axis, and the c-axis is to choose a unit cell in which a unique axis is used as the c-axis. In particular, in the case of a crystal having a layered structure, a general way of choosing a unit cell is to choose a unit cell in which two axes parallel to the plane direction of a layer are used as the a-axis and the b-axis and an axis intersecting with the layer is used as the c-axis. Typical examples of such a crystal having a layered structure include graphite, which is classified as a hexagonal system. In a unit cell of graphite, the a-axis and the b-axis are parallel to the cleavage plane and the c-axis is orthogonal to the cleavage plane. In this case, a plane parallel to the cleavage plane, i.e., a plane orthogonal to the c-axis in graphite, is referred to as the basal plane.

Lithium cobalt oxide having a layered rock-salt crystal structure has a feature that Li is easily distributed two-dimensionally in the direction parallel to the basal plane. In other words, the Li diffusion path extends along the basal plane. In this specification and the like, a plane where an end surface of a Li diffusion path is exposed, i.e., a plane where lithium ions are inserted and extracted, specifically, a plane other than the (001) plane, is referred to as the edge plane.

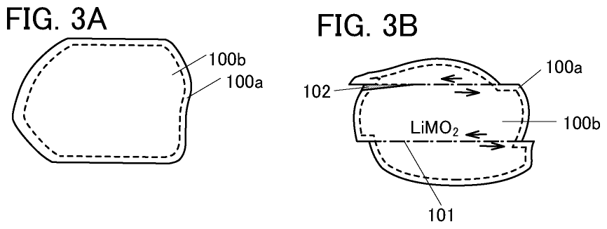

Examples of the positive electrode active material 100 are shown in FIGS. 3A and 3B, where the dashed lines indicate the boundary between the surface portion 100a and the inner portion 100b. In this manner, the surface portion 100a is distinguished from the inner portion 100b, and the surface portion 100a includes the surface.

Furthermore, in FIG. 3B, a dashed-dotted line indicates a crystal grain boundary 101. A crystal having a layered crystal structure typified by a layered rock-salt crystal structure has a feature that cleavage is likely to occur along a plane (here, the basal plane) parallel to a layer. As indicated by arrows in FIG. 3B, shift (slip) is caused along the cleavage planes in some cases. Therefore, the crystal grain boundary 101 is likely to be formed parallel to the basal plane. In this case, the crystal grain boundary 101 corresponds to the slip plane. A crack is formed in FIG. 3B and a filling portion 102 that is formed to fill the crack is shown. In a portion where a crack is formed in the positive electrode active material 100, the cleavage plane (i.e., the plane parallel to the basal plane) is likely to be exposed.

Lithium cobalt oxide is formed of a lithium layer (sometimes referred to as a lithium site) and a CoO₂ layer including an octahedral structure with cobalt coordinated to six oxygen atoms. The lithium layer has a planar structure and lithium ions can move along the planar surface in charging and discharging. LiCoO₂ has a layered rock-salt crystal structure of the space group R-3m, for example.

Here, the surface of the positive electrode active material 100 can be observed in a cross section. A metal oxide such as aluminum oxide (e.g., Al₂O₃) attached onto the surface of the positive electrode active material 100, and a carbonate, a hydroxy group, or the like chemically adsorbed onto the surface are not regarded as the surface of the positive electrode active material 100. Whether a metal oxide is one attached to the positive electrode active material 100 or not can be determined by whether crystal orientations of the metal oxide and the positive electrode active material 100 are aligned with each other.

Since the positive electrode active material 100 contains a compound of a transition metal and oxygen, the interface between a region where a transition metal M (e.g., Co, Ni, Mn, or Fe) and oxygen are present and a region where neither the transition metal M nor oxygen is present can be regarded as the surface of the positive electrode active material 100. A plane generated by slip or a crack can also be regarded as the surface of the positive electrode active material 100. Note that a protective film is sometimes attached to the surface of the positive electrode active material 100 in analysis thereof, thus, it is important to distinguish the surface of the positive electrode active material 100 from the protective film. As the protective film, a single-layer film or a multilayer film of carbon, a metal, an oxide, a resin, or the like may be used.

The surface of the positive electrode active material 100 in STEM-EDX line analysis or the like refers to a point where a value of the amount of the detected transition metal Mis equal to 50% of the sum of the average value M_{AVE} of the amount of the detected transition metal Min the inner portion 100b and the average value M_{BG} of the amount of the background transition metal M or a point where a value of the amount of the detected oxygen is equal to 50% of the sum of the average value O_{AVE} of the amount of detected oxygen in the inner portion 100b and the average value O_{BG} of the amount of background oxygen. Note that in the case where the positions of the points are different between the transition metal M and oxygen, the difference is probably due to the influence of a carbonate, a metal oxide containing oxygen, or the like, which is attached to the surface. Thus, the point where the value of the amount of the detected transition metal Mis equal to 50% of the sum of the average value M_{AVE} of the amount of the detected transition metal M in the inner portion 100b and the average value M_{BG} of the amount of the background transition metal M can be used. In the case where the positive electrode active material 100 contains a plurality of transition metals M, its surface can be determined using M_{AVE} and M_{BG} of the transition element with the largest detected amount in the inner portion 100b.

The average value M_{BG} of the amount of the background transition metal M can be calculated by averaging the amount in the range greater than or equal to 2 nm, preferably greater than or equal to 3 nm, which is outside a portion in the vicinity of the portion at which the amount of the detected transition metal M begins to increase, for example. The average value M_{AVE} of the amount of the detected transition metal Min the inner portion 100b can be calculated by averaging the amount in the range greater than or equal to 2 nm, preferably greater than or equal to 3 nm in a region where the numbers of the transition metals M and oxygen atoms are saturated and stabilized, e.g., a portion that is greater than or equal to 30 nm, preferably greater than 50 nm in depth from the portion where the amount of the detected transition metal M begins to increase, for example. The average value O_{BG} of the amount of background oxygen and the average value O_{AVE} of the amount of detected oxygen in the inner portion 100b can be calculated in a similar manner.

The surface of the positive electrode active material 100 in, for example, a cross-sectional STEM image is a boundary between a region where an image derived from the crystal structure of the positive electrode active material 100 is observed and a region where the image is not observed. The surface of the positive electrode active material 100 is also determined as the outermost surface of a region where an atomic column derived from an atomic nucleus of, among metal elements which constitute the positive electrode active material 100, a metal element that has a larger atomic number than lithium is observed in the cross-sectional STEM image. Alternatively, the surface refers to an intersection of a tangent drawn at a luminance profile from the surface toward the bulk and an axis in the depth direction in a STEM image.

The surface in a STEM image or the like may be judged employing also analysis with higher spatial resolution.

The spatial resolution of STEM-EDX is at least approximately 1 nm. Thus, the maximum value of an additive element profile may be shifted by 1 nm or more. For example, even when the maximum value of the profile of an additive element such as magnesium exists outside the surface determined in the above-described manner, it can be said that a difference between the maximum value and the surface is within the margin of error when the difference is less than 1 nm.

A peak in STEM-EDX line analysis refers to a local maximum value of the detection intensity in each element profile. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning a plurality of times or the average value can be used as the profile of each element.

STEM-EDX line analysis can be performed as follows. First, a protective film is deposited over a surface of a positive electrode active material. For example, carbon can be deposited with a carbon coating unit of an ion sputtering apparatus (MC1000, Hitachi High-Tech Corporation).

Next, the positive electrode active material is thinned to fabricate a cross-section sample to be subjected to STEM-EDX line analysis. For example, the positive electrode active material can be thinned with a focused ion beam (FIB)-SEM apparatus (XVision 200TBS, Hitachi High-Tech Corporation). Here, picking up can be performed by a micro probing system (MPS), and an accelerating voltage at final processing can be, for example, 10 kV.

The STEM-EDX line analysis can be performed using, for example, HD-2700 (Hitachi High-Tech Corporation) as a STEM apparatus and Octane T Ultra W (Dual EDS) of EDAX Inc as an EDX detector. In the EDX line analysis, the acceleration voltage of the STEM apparatus is set to 200 kV and the emission current is set to be in the range of 6 μA to 10 μA, and a portion of the thinned sample, which is not positioned at a deep level and has little unevenness, is measured. The magnification is 150,000 times, for example. The EDX line analysis can be performed under conditions where the beam diameter is 0.2 nm φ, drift correction is performed, the line width is 42 nm, the pitch is 0.2 nm, and the number of frames is 6 or more.

In STEM-EELS analysis, line analysis is possible as in EDX analysis, in which case electron beam irradiation needs to be performed longer than in EDX analysis. Thus, in the case where damage to a sample and an effect of drift on a sample are large, point analysis can be performed. In STEM-EELS analysis, for example, a TEMISTEM combined apparatus (JEM-ARM200F, JEOL Ltd.) can be used, MOS detector array can be used as a photoelectron spectrometer, and Quantum ER (Gatan Inc.) can be used as an element analysis apparatus. The EELS point analysis can be performed under conditions where the beam diameter is 0.1 nm φ and the acceleration voltage is 200 kV, for example.

### [Contained Elements]

Examples of the additive element contained in the positive electrode active material 100 include titanium, zirconium, vanadium, iron, manganese, chromium, niobium, arsenic, zinc, silicon, sulfur, phosphorus, boron, bromine, and beryllium in addition to Mg, F, Ni, and Al described above, and one or two or more of these elements can be used. The total percentage of the transition metal among the additive elements is preferably lower than 25 atomic %, further preferably lower than 10 atomic %, still further preferably lower than 5 atomic %.

The additive element may be dissolved in the positive electrode active material 100, and is preferably dissolved in the surface of the positive electrode active material 100, for example. Thus, in STEM-EDX line analysis, for example, a position where the amount of the detected additive element increases is preferably at a deeper level than a position where the amount of the detected transition metal Mincreases, i.e., on the inner portion side of the positive electrode active material 100.

### [Crystal Structure]

Next, the crystal structure of lithium cobalt oxide of one embodiment of the present invention is described. In lithium cobalt oxide used for the positive electrode active material 100, the lithium content changes with the charge and discharge state. Specifically, x represents the Li content in LiₓCoO₂. For example, the lithium content is maximized in a secondary battery in an ideal discharged state, in which case x=1. Meanwhile, lithium ions are extracted from lithium cobalt oxide when charging is performed, and thus x becomes smaller. A crystal structure in the state where x is 1 and a crystal structure in the state where x is less than 1 differ and thus are separately described below.

{x is 1}

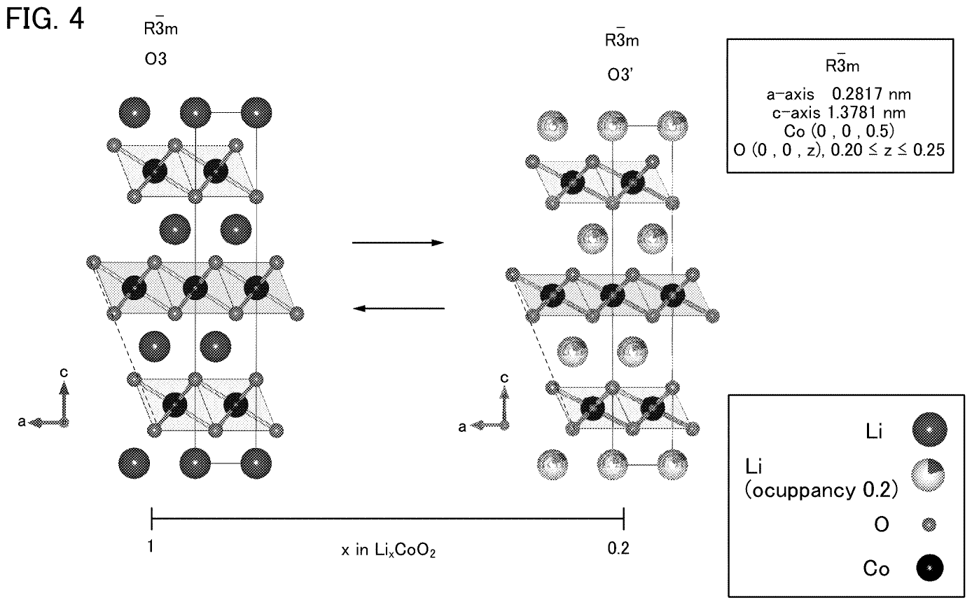

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt crystal structure is preferred as a positive electrode active material of a secondary battery because it has high discharge capacity and a two-dimensional diffusion path for lithium ions and thus is suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 4, the layered rock-salt crystal structure is denoted by R-3m O3.

The surface portion 100a of the positive electrode active material 100 preferably has a function of reinforcing the layered structure to be maintained even when a large number of lithium ions are extracted from the positive electrode active material 100 due to charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means at least one of inhibition of a change in the structures of the surface portion 100a and the inner portion 100b of the positive electrode active material 100 such as extraction of oxygen and inhibition of oxidative decomposition of an electrolyte on the surface of the positive electrode active material 100.

The surface portion 100a preferably has a composition and a crystal structure different from those of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and is more likely to have a low lithium concentration than the inner portion 100b. It can be said that bonds between atoms are partly cut on the surface of the particle of the positive electrode active material 100 included in the surface portion 100a. Therefore, the surface portion 100a is regarded as a region which is likely to be unstable and in which deterioration of the crystal structure is likely to begin. Meanwhile, if the surface portion 100a can have sufficient stability, the layered structure of the inner portion 100b can be difficult to break even when the Li content is small, i.e., x is small (e.g., x is 0.24 or less). Furthermore, shift in layers of the inner portion 100b can be inhibited.

The surface portion 100a contains the above additive elements at appropriate concentrations and with appropriate concentration distributions, whereby the layered structure of the inner portion 100b can be inhibited from being broken due to insertion and extraction of lithium ions, enabling the positive electrode active material 100 to have high reliability.

In the inner portion 100b of the positive electrode active material 100, the density of defects such as dislocation is preferably low. In the positive electrode active material 100, the crystallite size measured by XRD is preferably large. In other words, the inner portion 100b preferably has high crystallinity. Furthermore, the positive electrode active material 100 preferably has a smooth surface. These features are important factors for assuring the reliability of the positive electrode active material 100 in a secondary battery. A secondary battery can have a high upper limit of a charge voltage when including a highly reliable positive electrode active material and thereby can have high charge and discharge capacity.

Dislocation in the inner portion 100b can be observed with a TEM, for example. Defects such as dislocation are sometimes not observed in a specific 1-μm² region of an observation sample in the case where the density of defects such as dislocation is sufficiently low. Note that dislocation is a kind of crystal defect and is different from a point defect.

The crystallite size measured by XRD is preferably larger than or equal to 300 nm, for example. The larger the crystallite size is, the more easily the O3′ type structure is maintained and contraction of the c-axis length is inhibited in the state where x in LiₓCoO₂ is small as described later.

It is presumed that the crystallite size measured by XRD is larger when fewer defects such as dislocation are observed with a TEM.

To obtain an XRD pattern for calculation of a crystallite size, a positive electrode that includes a positive electrode active material, a current collector, a binder, a conductive material, and the like may be subjected to XRD, although it is preferable that only the positive electrode active material be subjected to XRD. Note that the positive electrode active material particles present in the positive electrode might be oriented such that the crystal planes of the positive electrode active material particles are oriented in the same direction owing to, for example, pressure application in a formation process. When many of the positive electrode active material particles are oriented in the above manner, the crystallite size might fail to be calculated accurately; thus, it is preferable that to obtain an XRD pattern, a positive electrode active material layer be taken out from the positive electrode, the binder and the like in the positive electrode active material layer be eliminated to some extent using a solvent or the like, and a sample holder be filled with the resultant positive electrode active material, for example. Alternatively, a powder sample of the positive electrode active material or the like may be attached onto a reflection-free silicon plate to which grease is applied, for example.

The crystallite size can be calculated using ICSD coll. code. 172909 as literature data of lithium cobalt oxide and a diffraction pattern that is obtained with Bruker D8 ADVANCE, for example, under the following conditions: CuKuα is used as an X-ray source, the 2θ range is from 15° to 90°, an increment is 0.005, and a detector is LYNXEYE XE-T. Analysis can be conducted using DIFFRAC.TOPAS ver. 6 as crystal structure analysis software, and exemplary settings are as follows.

Emission Profile: CuKa5.lam
Background: Chebychev polynomial of degree 5
Instrument
Primary radius: 280 mm
Secondary radius: 280 mm
Linear PSD
2Th angular range: 2.9
FDS angle: 0.3
Full Axial Convolution
Filament length: 12 mm
Sample length: 15 mm
Receiving Slit length: 12 mm
Primary Sollers: 2.5
Secondary Sollers: 2.5
Corrections
Specimen displacement: Refine
LP Factor: 0

Among some values calculated in the above method, a value of LVol-IB is preferably employed as a crystallite size. Note that in a sample whose preferred orientation is calculated to be less than 0.8, too many particles are oriented in the same direction; thus, this sample is not suitable for calculation of a crystallite size in some cases.

### {Distribution of Additive Element}

The distribution of the additive element in the positive electrode active material 100 in a discharged state (i.e., x=1) is described as an example. To obtain a stable composition and a stable crystal structure of the surface portion 100a, the surface portion 100a preferably contains the additive element, further preferably a plurality of additive elements. The surface portion 100a preferably has a higher concentration of one or more selected from the additive elements than the inner portion 100b. The one or more selected from the additive elements contained in the positive electrode active material 100 preferably have a concentration gradient. In addition, it is further preferable that the additive elements contained in the positive electrode active material 100 be differently distributed. For example, it is preferable that the additive elements exhibit concentration peaks at different depths from a surface. The concentration peak here refers to a local maximum value of the detected amount in the surface portion 100a or in a region of 50 nm or less in depth from the surface.

For example, some of the additive elements such as magnesium, fluorine, nickel, titanium, silicon, phosphorus, boron, and calcium preferably have a concentration gradient in which the concentration increases from the inner portion 100b toward the surface. An additive element which has such a concentration gradient is referred to as an additive element X. In some cases, the additive element X is not contained in the inner portion 100b (the additive element X is not observed or the amount of the additive element X is the lower detection limit or less).

It is preferable that another additive element such as aluminum or manganese have a concentration gradient and exhibit a concentration peak in a relatively deeper region than the additive element X. The concentration peak may be located in the surface portion 100a or located deeper than the surface portion 100a. For example, the concentration peak is preferably located in a region of 5 nm to 30 nm inclusive in depth perpendicular or substantially perpendicular from the surface. An additive element which has such a concentration gradient is referred to as an additive element Y.

For example, magnesium, which is one of the additive elements X, is divalent, and a magnesium ion is more stable in lithium sites than in transition metal M sites in the layered rock-salt crystal structure and thus is likely to enter the lithium sites. An appropriate concentration of magnesium at the lithium sites of the surface portion 100a facilitates maintenance of the layered rock-salt crystal structure. This is probably because magnesium at the lithium sites serves as a column supporting the CoO₂ layers. Thus, magnesium can inhibit extraction of oxygen therearound in a state where x in LiₓCoO₂ is, for example, 0.24 or less. Magnesium is also expected to increase the density of the positive electrode active material 100. In addition, a high magnesium concentration in the surface portion 100a probably increases the corrosion resistance to hydrofluoric acid generated by the decomposition of the electrolyte solution.

An appropriate magnesium concentration does not adversely affect insertion and extraction of lithium ions in charging and discharging, while too high a magnesium concentration might adversely affect the insertion and extraction. Furthermore, the effect of stabilizing the crystal structure might be reduced. This is probably because magnesium enters the transition metal M sites in addition to the lithium sites. Moreover, an undesired magnesium compound (e.g., an oxide or a fluoride) which is substituted for neither the lithium site nor the transition metal M site might segregate at the surface of the positive electrode active material or the like to serve as a resistance component of the secondary battery. Furthermore, the discharge capacity of the positive electrode active material might be reduced in some cases. This is probably because excess magnesium is substituted for the lithium sites and the amount of lithium contributing to charging and discharging decreases.

Thus, the entire positive electrode active material 100 preferably contains an appropriate amount of magnesium. For example, the proportion of magnesium in the sum of the transition metal M (Mg/Co) in the positive electrode active material 100 of one embodiment of the present invention is preferably higher than or equal to 0.25% and lower than or equal to 5%, further preferably higher than or equal to 0.5% and lower than or equal to 2%, still further preferably approximately 1%. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be a value based on the ratio of the raw materials mixed in the process of forming the positive electrode active material 100.

Nickel, which is an example of the additive elements X, can be present at both the transition metal M sites and the lithium sites. Nickel is preferably present at the transition metal M sites because a lower redox potential can be obtained as compared with the case where only cobalt is present at the transition metal M sites, leading to an increase in discharge capacity.

In addition, when nickel is present at lithium sites, shift in the layered structure formed of octahedrons of the transition metal M and oxygen can be inhibited. Moreover, a change in volume in charging and discharging is inhibited. Furthermore, an elastic modulus becomes large, i.e., hardness increases. This is probably because as well as magnesium, nickel at the lithium sites also serves as a column supporting the CoO₂ layers. Therefore, in particular, the crystal structure is expected to be more stable in a charged state at high temperatures, e.g., 45° C. or higher, which is preferable.

Meanwhile, excess nickel might increase the influence of distortion due to the Jahn-Teller effect. Moreover, excess nickel might adversely affect insertion and extraction of lithium ions.

Thus, the entire positive electrode active material 100 preferably contains an appropriate amount of nickel. For example, the number of nickel atoms in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

Aluminum, which is an example of the added element Y, can be present at the transition metal M site in a layered rock-salt crystal structure. Since aluminum is a trivalent representative element and its valence does not change, lithium around aluminum is less likely to move even in charging and discharging. Thus, aluminum and lithium around aluminum serve as columns to inhibit a change in the crystal structure. Furthermore, aluminum has an effect of inhibiting elution of the transition metal M around aluminum and improving continuous charging tolerance. Moreover, an Al—O bond is stronger than a Co—O bond and thus release of oxygen around aluminum can be inhibited. These effects improve thermal stability. Therefore, a secondary battery that contains aluminum as the additive element Y can have a higher degree of safety. In addition, the positive electrode active material 100 having a crystal structure that is unlikely to be broken by repeated charging and discharging can be provided.

Meanwhile, excess aluminum might adversely affect insertion and extraction of lithium ions. The number of aluminum atoms in the entire positive electrode active material 100 is, for example, preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% or greater than or equal to 0.1% and less than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

When fluorine, which is a monovalent anion and is an example of the additive element X, is substituted for part of oxygen in the surface portion 100a, the lithium ion extraction energy is lowered. This is because the change in valence of cobalt ions associated with lithium ion extraction is trivalent to tetravalent in the case of not containing fluorine and divalent to trivalent in the case of containing fluorine, and the redox potential differs therebetween. It can thus be said that when fluorine is substituted for part of oxygen in the surface portion 100a of the positive electrode active material 100, lithium ions near fluorine are likely to be extracted and inserted smoothly. Thus, a secondary battery including such a positive electrode active material 100 can have improved charge and discharge characteristics, improved current characteristics, or the like. When fluorine is present in the surface portion 100a, which has a surface in contact with the electrolyte solution, the corrosion resistance to hydrofluoric acid can be effectively increased. A fluoride such as lithium fluoride that has a lower melting point than a different additive element source can serve as a fusing agent (also referred to as a flux) for lowering the melting point of the different additive element source.

An oxide of titanium, which is an example of the additive element X, is known to have superhydrophilicity. Accordingly, the positive electrode active material 100 that contains titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

When the surface portion 100a contains both magnesium and nickel, divalent magnesium might be able to be present more stably in the vicinity of divalent nickel. Thus, even when x in LiₓCoO₂ is small, elution of magnesium might be inhibited, which might contribute to stabilization of the surface portion 100a.

Additive elements that are differently distributed, such as the additive element X and the additive element Y, are preferably contained at a time, in which case the crystal structure of a wider region can be stabilized. For example, the crystal structure of a wider region can be stabilized in the case where the positive electrode active material 100 contains all of magnesium and nickel, which are examples of the additive element X, and aluminum, which is an example of the additive element Y, as compared with the case where only the additive element X or the additive element Y is contained. In the case where the positive electrode active material 100 contains both the additive element X and the additive element Y as described above, the surface can be sufficiently stabilized by the additive element X such as magnesium and nickel; thus, the additive element Y such as aluminum is not necessary for the surface. On the contrary, aluminum is preferably widely distributed in a deep region, e.g., in a region that is 5 nm to 50 nm inclusive in depth from the surface, in which case the crystal structure in a wider region can be stabilized.

Meanwhile, too high a concentration of the additive element might reduce path through which lithium ions are inserted and extracted. To ensure the sufficient path through which lithium ions are inserted and extracted, the concentration of cobalt is preferably higher than that of magnesium in the surface portion 100a. For example, the atomic ratio of magnesium to cobalt (Mg/Co) is preferably less than or equal to 0.62. In addition, the concentration of cobalt is preferably higher than those of nickel, aluminum, and fluorine in the surface portion 100a.

It is preferable that the crystal structure continuously change from the inner portion 100b toward the surface owing to the above-described concentration gradient of the additive element. Alternatively, it is preferable that the surface portion 100a and the inner portion 100b have substantially the same crystal orientation.

Note that in this specification and the like, a layered rock-salt crystal structure that belongs to the space group R-3m of a composite oxide containing lithium and the transition metal M such as cobalt refers to a crystal structure in which a rock-salt ion arrangement where cations and anions are alternately arranged is included and lithium and the transition metal Mare each regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may exist.

The orientations of crystals in two regions being substantially aligned with each other can be judged, for example, from a TEM image, a STEM image, a high-angle annular dark field STEM (HAADF-STEM) image, an annular bright-field STEM (ABF-STEM) image, an enhanced hollow-cone illumination TEM (eHCI-TEM) image, an electron diffraction pattern, or the like. It can be judged also from an FFT pattern of a TEM image, an FFT pattern of a STEM image, or the like. XRD, neutron diffraction, and the like can also be used for judging.

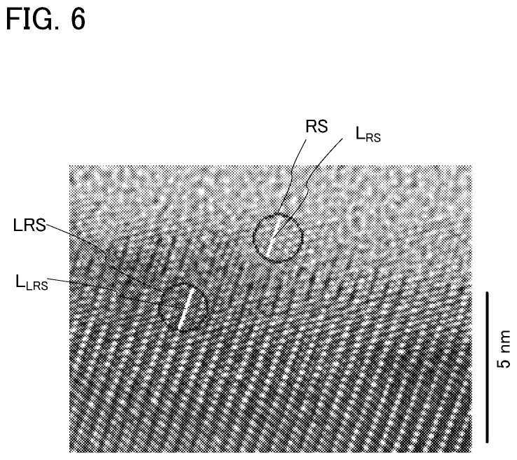

FIG. 6 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image showing a crystal structure is obtained.

For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 6) or between the dark lines is greater than or equal to 0° and less than or equal to 5°, preferably less than or equal to 2.5° in the TEM image, it can be judged that the crystal planes are substantially aligned with each other, that is, orientations of the crystals are substantially aligned with each other.

In a HAADF-STEM image, a contrast corresponding to the atomic number is obtained, and an element having a larger atomic number is observed to be brighter. For example, in the case of lithium cobalt oxide, arrangement of cobalt atoms having the largest atomic number is observed as bright lines or arrangement of high-luminance dots. When observed from the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis.

Consequently, in the case where repetition of bright lines and dark lines is observed in two regions having different crystal structures and the angle between the bright lines or between the dark lines is 5° or less or preferably 2.5° or less in a HAADF-STEM image, it can be judged that arrangements of the atoms are substantially aligned with each other, and orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

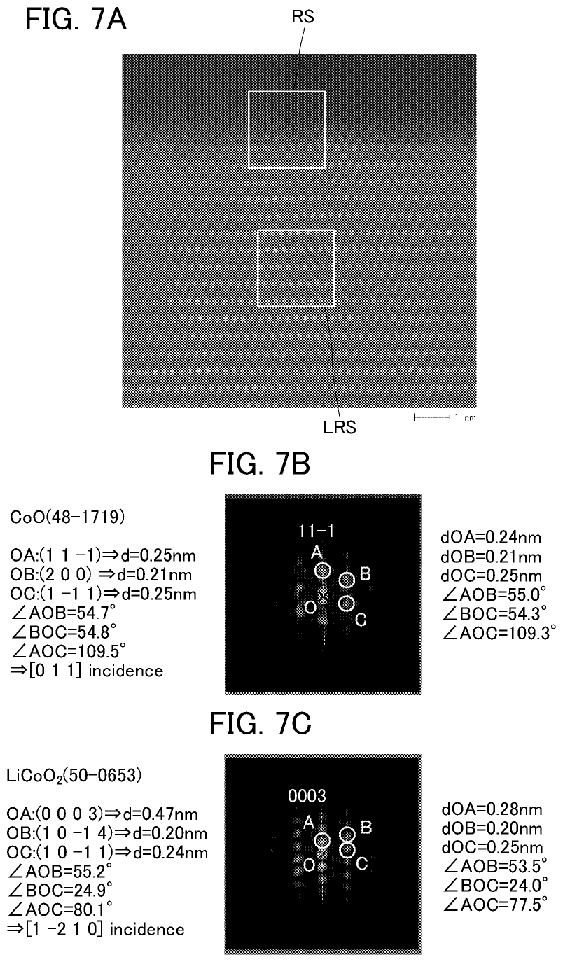

FIG. 7A shows an example of a STEM image in which orientations of the layered rock-salt crystal LRS and the rock-salt crystal RS are substantially aligned with each other. FIG. 7B shows an FFT pattern of a region of the rock-salt crystal RS, and FIG. 7C shows an FFT pattern of a region of the layered rock-salt crystal LRS. In FIGS. 7B and 7C, the composition, the joint committee on powder diffraction standard (JCPDS) card number, and d values and angles to be calculated are shown on the left. The measured values are shown on the right. A spot denoted by O is zero-order diffraction, and X denotes the center of the spot.

A spot denoted by A in FIG. 7B is derived from 11-1 reflection of a cubic structure. A spot denoted by A in FIG. 7C is derived from 0003 reflection of a layered rock-salt crystal structure. It is found from FIG. 7B and FIG. 7C that the direction of the 11-1 reflection of the cubic structure and the direction of the 0003 reflection of the layered rock-salt crystal structure are substantially aligned with each other. That is, a straight line that passes through AO in FIG. 7B is substantially parallel to a straight line that passes through AO in FIG. 7C. Here, the terms “substantially aligned” and “substantially parallel” mean that the angle between the two is greater than or equal to 0° and less than or equal to 5°, preferably greater than or equal to 0° and less than or equal to 2.5°.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal are substantially aligned with each other.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 7C is derived from 10-14 reflection of the layered rock-salt crystal structure. Similarly, a spot that is not derived from the 11-1 reflection of the cubic structure may be observed on a reciprocal lattice space different from the direction where the 11-1 reflection of the cubic structure is observed. For example, a spot denoted by B in FIG. 7B is derived from 200 reflection of the cubic structure.

To judge alignment of crystal orientations, a sample is preferably processed to be thin so that the (0003) plane of the layered rock-salt crystal structure is easily observed. Thus, for example, a sample to be observed is preferably processed to be thin using an FIB or the like such that an electron beam of a TEM, for example, enters in [1-210]. It is known that in a layered rock-salt positive electrode active material, such as lithium cobalt oxide, the (0003) plane and a plane equivalent thereto and the (10-14) plane and a plane equivalent thereto are likely to be crystal planes. Thus, through careful observation of the shape of the positive electrode active material with a SEM or the like, a sample to be observed can be processed to be thin so that the (0003) plane is easily observed.

### {x is Small}

The crystal structure in a state where x in LiₓCoO₂ is small of the positive electrode active material 100 of one embodiment of the present invention is different from that of a conventional positive electrode active material because the positive electrode active material 100 has the above-described additive element distribution and crystal structure in a discharged state. Here, “x is small” means 0.1<x≤0.24.

A conventional positive electrode active material and the positive electrode active material 100 of one embodiment of the present invention are compared, and changes in the crystal structures owing to a change in x in LiₓCoO₂ are described below.

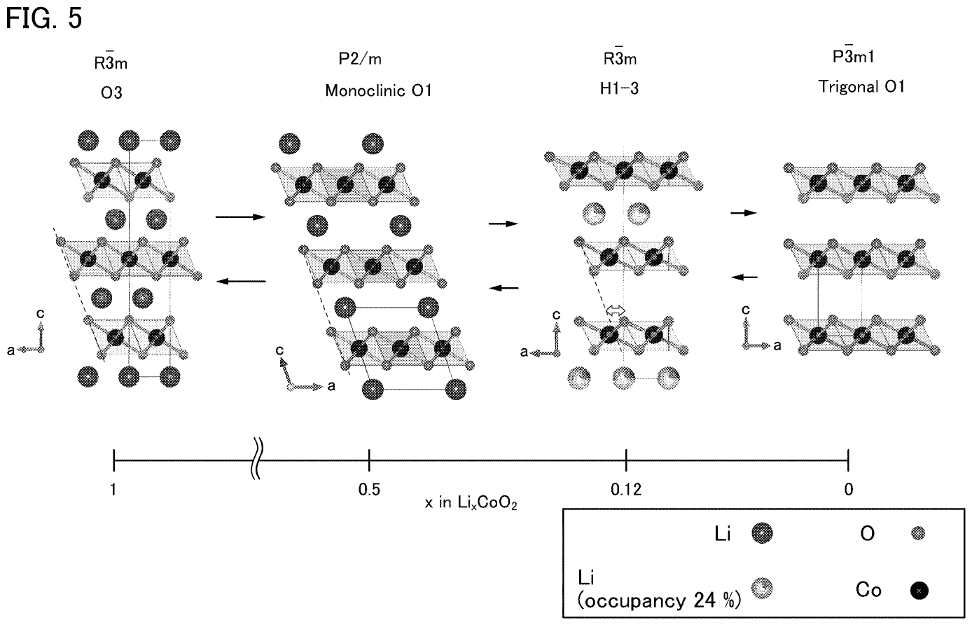

A change in the crystal structure of the conventional positive electrode active material is shown in FIG. 5. The conventional positive electrode active material shown in FIG. 5 is lithium cobalt oxide (LiCoO₂) containing no additive element. A change in the crystal structure of lithium cobalt oxide containing no additive element is described in Non-Patent Documents 1 to 4 and the like. For example, VESTA (Non-Patent Document 5) or the like can be used for drawing the crystal structures as shown in FIG. 5.

On the left side of FIG. 5, the crystal structure of lithium cobalt oxide with x in LiₓCoO₂ of 1 is denoted by R-3m O3. A unit cell of this crystal structure includes three CoO₂ layers and lithium is positioned between the CoO₂ layers. Furthermore, lithium occupies octahedral sites with six coordinated oxygen. Thus, this crystal structure is referred to as an O3 type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen. The coordinates of lithium, cobalt, and oxygen in a unit cell of R-3m O3 can be represented by Li (0, 0, 0), Co (0, 0, 0.5), and O (0, 0, 0.23951).

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3 ml and includes one CoO₂ layer in a unit cell. Hence, this crystal structure is referred to as an O1 type structure or a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as a structure belonging to R-3m O3 are alternately stacked. Thus, this crystal structure is referred to as an H1-3 type structure in some cases. Note that since insertion and extraction of lithium ions do not necessarily uniformly occur in reality, the H1-3 type structure is started to be observed when x is approximately 0.25 in practice. The number of cobalt atoms per unit cell in the actual H1-3 type structure is twice that in other structures. However, in this specification including FIG. 5, the c-axis of the H1-3 type structure is half that of the unit cell for easy comparison with the other crystal structures.

For the H1-3 type structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O1 and O2 are each an oxygen atom. A preferred unit cell for representing a crystal structure in a positive electrode active material can be selected by Rietveld analysis of XRD patterns, for example. In this case, a unit cell is selected such that the value of goodness of fit (GOF) is small.

When charging that makes x in LiₓCoO₂ be 0.24 or less and discharging are repeated, the crystal structure of conventional lithium cobalt oxide repeatedly changes between the H1-3 type structure and the R-3m O3 structure in a discharged state (i.e., an unbalanced phase change).

However, there is a large shift in the CoO₂ layers between these two crystal structures. As denoted by the dotted lines and the arrow in FIG. 5, the CoO₂ layer in the H1-3 type structure largely shifts from that in the structure belonging to R-3m O3 in a discharged state. Such a dynamic structural change can adversely affect the stability of the crystal structure. A difference in volume between the two crystal structures is also large. When the H1-3 type structure and the R-3m O3 type structure in a discharged state contain the same number of cobalt atoms, these structures have a difference in volume of greater than 3.5%, typically greater than or equal to 3.9%.

Accordingly, when charging that makes x be 0.24 or less and discharging are repeated, the crystal structure of conventional lithium cobalt oxide is gradually broken. The broken crystal structure triggers deterioration of the cycle performance. This is because the broken crystal structure has a smaller number of sites where lithium ions can be present stably and makes it difficult to insert and extract lithium ions.

Next, the positive electrode active material 100 of one embodiment of the present invention is described. FIG. 4 shows crystal structures of the positive electrode active material 100 of one embodiment of the present invention. Here, crystal structures of the inner portion 100b of the positive electrode active material 100 in a state where x in LiₓCoO₂ is 1 and in a state where x is approximately 0.2 are shown side by side. The inner portion 100b, accounting for the majority of the volume of the positive electrode active material 100, largely contributes to charging and discharging and is accordingly a portion where a shift in CoO₂ layers and a volume change matter most.

In the positive electrode active material 100 of one embodiment of the present invention, a change in the crystal structure between a discharged state with x in LiₓCoO₂ of 1 and a state with x of 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charging that makes x be 0.24 or less and discharging are repeated, and obtain excellent cycle performance. In addition, the positive electrode active material 100 of one embodiment of the present invention with x in LiₓCoO₂ of 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of a secondary battery is further improved.

The positive electrode active material 100 has the R-3m O3 type structure in a state where x is 1, like conventional lithium cobalt oxide. The positive electrode active material 100, however, can have a crystal structure different from the H1-3 type structure even when x has a small value (x is 0.24 or less, e.g., approximately 0.2 or 0.12).

Specifically, the positive electrode active material 100 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is referred to as an O3′ type structure. In FIG. 4, this crystal structure is denoted by R-3m O3′.

In the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 0.2797 nm≤a≤0.2837 nm, further preferably 0.2807 nm≤a≤0.2827 nm, typically a=0.2817 nm. The lattice constant of the c-axis is preferably 1.3681 nm≤c≤1.3881 nm, further preferably 1.3751 nm≤c≤1.3811 nm, typically, c=1.3781 nm.

In the O3′ type structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 4, the CoO₂ layers hardly shift between the R-3m (O3) type structure in a discharged state and the O3′ type structure.

The R-3m (O3) type structure in a discharged state and the O3′ type structure that contain the same number of cobalt atoms have a difference in volume of 2.5% or less, specifically 2.2% or less, typically 1.8%.

As described above, in the positive electrode active material 100 of one embodiment of the present invention, a change in the crystal structure from the state where lithium ions are packed to the state where a large number of the lithium ions are extracted can be inhibited as compared to a conventional positive electrode active material. Moreover, a change in volume in the positive electrode active material 100 is also smaller than in the conventional positive electrode active material, in the case where the positive electrode active materials having the same number of cobalt atoms are compared. Thus, the crystal structure of the positive electrode active material 100 is less likely to be broken even when charging that makes x be 0.24 or less and discharging are repeated. Therefore, charge and discharge capacity in charge and discharge cycles are less likely to be decreased. Furthermore, the positive electrode active material 100 can stably use a large amount of lithium than a conventional positive electrode active material and thus has large discharge capacity per weight and per volume. Thus, with the use of the positive electrode active material 100, a secondary battery with large discharge capacity per weight and per volume can be manufactured.

Note that insertion and extraction of lithium ions do not uniformly occur; even when x in LiₓCoO₂ in the positive electrode active material 100 is greater than 0.1 and less than or equal to 0.24, not the entire inner portion 100b of the positive electrode active material 100 has to have the O3′ type structure. Another crystal structure may be contained, or part of the inner portion 100b may be amorphous.

In order to make x in LiₓCoO₂ small, charging at a high charge voltage is necessary in general. Therefore, the state where x in LiₓCoO₂ is small can be rephrased as a state where charging at a high charge voltage has been performed. For example, when CC/CV charging is performed at 25° C. and 4.6 V or higher using the potential of a lithium metal as a reference, the H1-3 type structure appears in a conventional positive electrode active material. Therefore, a charge voltage of 4.6 V or higher can be regarded as a high charge voltage with reference to the potential of a lithium metal. In this specification and the like, unless otherwise specified, charge voltage is shown with reference to the potential of a lithium metal.

That is, the positive electrode active material 100 of one embodiment of the present invention is preferable because the R-3m O3 structure having symmetry can be maintained even when charging at a high charge voltage, e.g., 4.6 V or higher is performed at 25° C. Moreover, the positive electrode active material 100 of one embodiment of the present invention is preferable because the O3′ type structure can be obtained when charging at a higher charge voltage, e.g., a voltage higher than or equal to 4.65 V and lower than or equal to 4.7 V is performed at 25° C.

At a far higher charge voltage, the H1-3 type structure is eventually observed in the positive electrode active material 100 in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′ type structure even at a lower charge voltage, e.g., a charge voltage of higher than or equal to 4.5 V and lower than 4.6 V at 25° C.

Note that in the case where graphite is used as a negative electrode active material in a secondary battery, the voltage of the secondary battery is lower than the above-mentioned voltages by a difference between the potential of lithium metal and the potential of graphite. The potential of graphite is approximately 0.05 V to 0.2 V with reference to the potential of a lithium metal. Therefore, in the case of a secondary battery using graphite as a negative electrode active material, a similar crystal structure is obtained at a voltage corresponding to a difference between the above-described voltage and the potential of the graphite.

Although a chance of the presence of lithium in all lithium sites is the same in the O3′ type structure in FIG. 4, the present invention is not limited thereto. Lithium may be present unevenly in only some of the lithium sites. For example, lithium may be symmetrically present as in the monoclinic O1 type structure (Li_{0.5}CoO₂) in FIG. 5. Distribution of lithium can be analyzed by neutron diffraction, for example.

The additive-element concentration gradient is preferably similar in a plurality of portions of the surface portion 100a of the positive electrode active material 100. In other words, it is preferable that a barrier film derived from the additive element be uniformly formed in the surface portion 100a. When the surface portion 100a partly has reinforcement, stress might be concentrated on parts that do not have reinforcement. The concentration of stress on part of the positive electrode active material 100 might cause defects such as cracks from that part, leading to cracking of the positive electrode active material and a decrease in discharge capacity.

### [Crystal Grain Boundary]

It is further preferable that the additive element contained in the positive electrode active material 100 of one embodiment of the present invention have the above-described distribution and be at least partly unevenly distributed at the crystal grain boundary 101 and the vicinity thereof.

In this specification and the like, uneven distribution refers to a state where a concentration of a certain element in a certain region is different from that in other regions, and may be rephrased as segregation, precipitation, unevenness, deviation, a mixture of a high-concentration portion and a low-concentration portion, or the like.

For example, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b. In addition, the nickel concentration at the crystal grain boundary 101 and the vicinity thereof is preferably higher than that in the other regions in the inner portion 100b. In addition, the aluminum concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the particle. Thus, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

### [Particle Diameter]

When the particle diameter of the positive electrode active material 100 of one embodiment of the present invention is too large, there are problems such as difficulty in lithium ion diffusion and large surface roughness of an active material layer at the time when the material is applied to a current collector. By contrast, too small a particle diameter causes problems such as overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the median diameter (D50) is preferably greater than or equal to 1 μm and less than or equal to 40 μm, greater than or equal to 1 μm and less than or equal to 30 μm, greater than or equal to 2 μm and less than or equal to 100 μm, greater than or equal to 2 μm and less than or equal to 30 μm, greater than or equal to 5 μm and less than or equal to 100 μm, or greater than or equal to 5 μm and less than or equal to 40 μm.

A positive electrode is preferably formed using a mixture of particles having different particle diameters to have an increased electrode density and enable a high energy density of a secondary battery. The positive electrode active material 100 with a relatively small particle diameter is expected to enable favorable charge and discharge rate characteristics. The positive electrode active material 100 with a relatively large particle diameter is expected to achieve excellent charge and discharge cycle performance and maintenance of high discharge capacity.

In the case where a positive electrode is formed using a mixture of particles having different median diameters (D50), the speed at which x in LiₓCoO₂ decreases is higher in the positive electrode active material 100 with a relatively small particle diameter than in the positive electrode active material 100 with a relatively large particle diameter, on the assumption that extraction of lithium ions starts from the surface of the positive electrode active material. Thus, both the O3′ type structure and the monoclinic O1(15) type structure are sometimes detected when powder XRD measurement is performed on a positive electrode active material formed using a mixture of particles having different particle diameters.

### [Analysis Method]

### {Evaluation of Crystal Structure}

Whether or not a given positive electrode active material is the positive electrode active material 100 of one embodiment of the present invention, which has the O3′ type structure and/or the monoclinic O1(15) type structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example. The peaks appearing in the powder XRD patterns reflect the crystal structure of the inner portion 100b of the positive electrode active material 100, which accounts for the majority of the volume of the positive electrode active material 100.

In the case where the crystallite size is measured by powder XRD, the measurement is preferably performed while the adverse effect of orientation due to pressure application or the like is eliminated. For example, it is preferable that the positive electrode active material be taken out from a positive electrode obtained from a disassembled secondary battery, the positive electrode active material be made into a powder sample, and then the measurement be performed.

As described above, the feature of the positive electrode active material 100 of one embodiment of the present invention is a small change in the crystal structure between a state with x in LiₓCoO₂ of 1 and a state with x of 0.24 or less. A material 50% or more of which has the crystal structure that will be largely changed by high-voltage charging is not preferable because the material cannot withstand repetition of high-voltage charging and discharging.

It should be noted that the O3′ type structure or the monoclinic O1(15) type structure is not obtained in some cases only by addition of the additive element. For example, in a state with x in LiₓCoO₂ of 0.24 or less, lithium cobalt oxide containing magnesium and fluorine or lithium cobalt oxide containing magnesium and aluminum has the O3′ type structure and/or the monoclinic O1(15) type structure at 60% or more in some cases, and has the H1-3 type structure at 50% or more in other cases, depending on the concentration and distribution of the additive element.

In addition, in a state where x is too small, e.g., 0.1 or less, or a charge voltage is higher than 4.9 V, the positive electrode active material 100 of one embodiment of the present invention sometimes has the H1-3 type structure or the trigonal O1 type structure. Thus, to determine whether or not a positive electrode active material is the positive electrode active material 100 of one embodiment of the present invention, analysis of the crystal structure by XRD and other methods and data such as charge capacity or charge voltage are needed.

Note that the crystal structure of a positive electrode active material in a state with small x may be changed with exposure to the air. For example, the O3′ type structure and the monoclinic O1(15) type structure change into the H1-3 type structure in some cases. For that reason, all samples subjected to analysis of the crystal structure are preferably handled in an inert atmosphere such as an argon atmosphere.

Whether the additive element contained in a positive electrode active material has the above-described distribution can be judged by analysis using XPS, EDX, electron probe microanalysis (EPMA), or the like.

The crystal structure of the surface portion 100a, the crystal grain boundary 101, or the like can be analyzed by electron diffraction of a cross section of the positive electrode active material 100, for example.

### {XRD}

The apparatus and conditions adopted in the XRD measurement are not particularly limited as long as appropriate adjustment and calibration are performed. For example, D8 ADVANCE (Bruker AXS) can be used as the measurement apparatus.

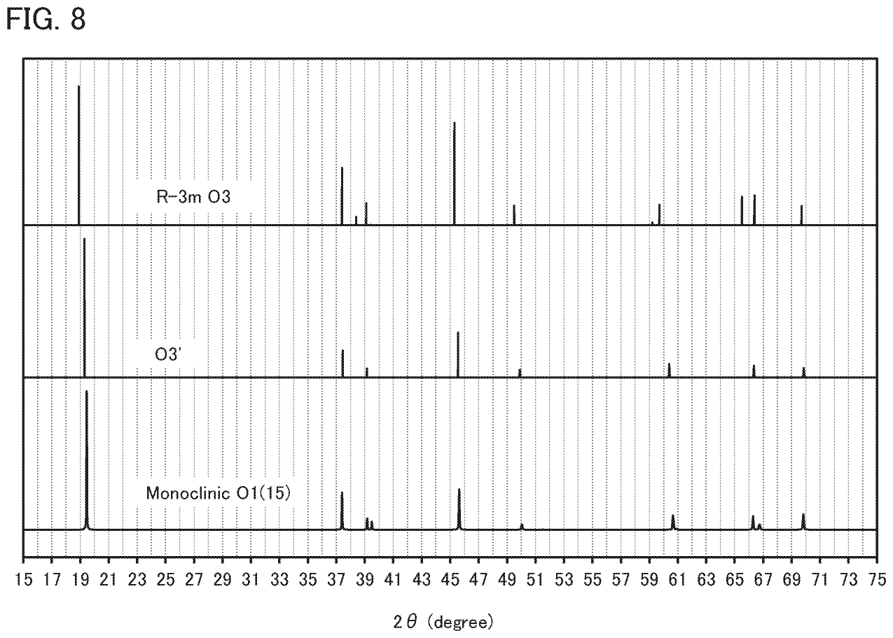

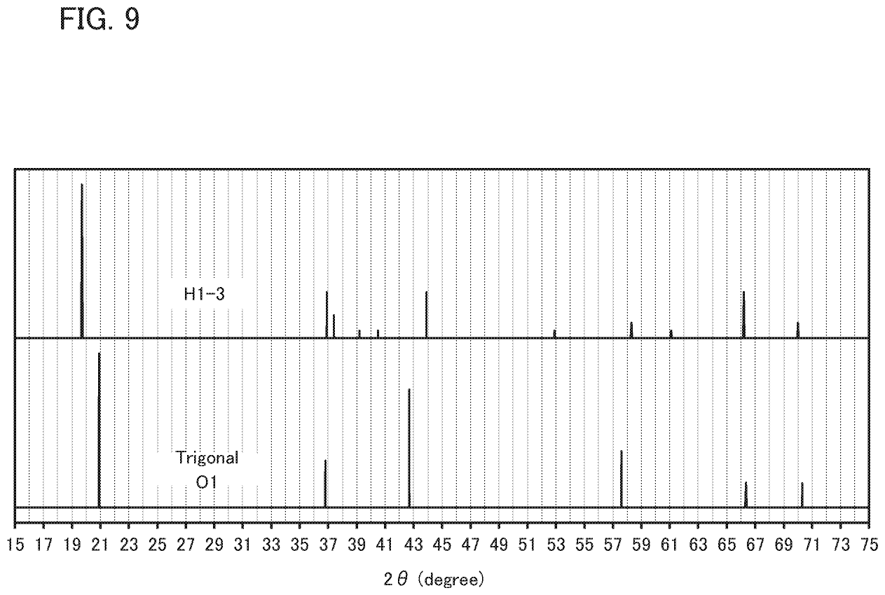

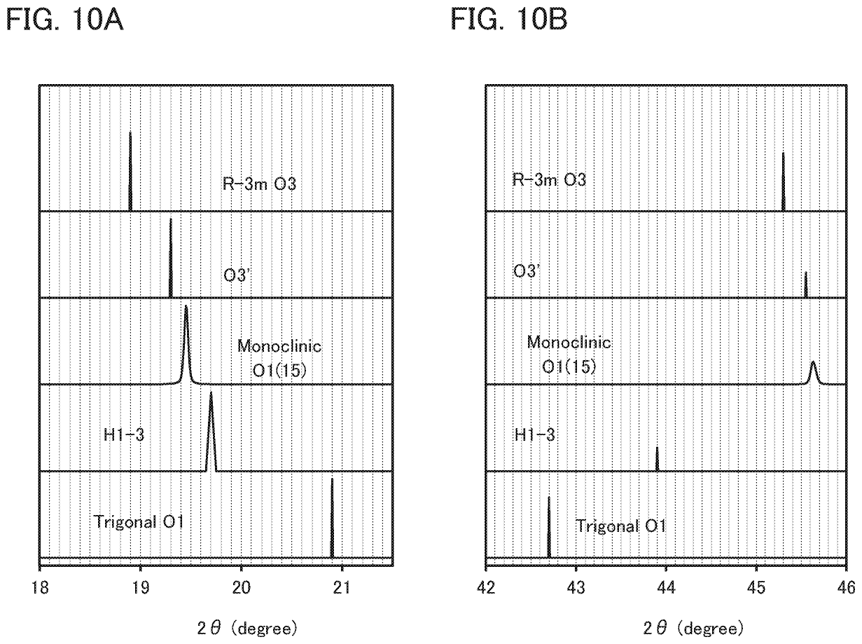

FIG. 8 shows diffraction profiles of the O3 type structure, the O3′ type structure, and the monoclinic O1(15) type structure of the case where CuKα₁ is used as a radiation source. FIG. 9 shows ideal XRD patterns with CuKα₁ radiation calculated from a model of the H1-3 type structure and from a model of the trigonal O1 type structure. FIG. 10A shows all of the above-described XRD patterns in the 2θ range of 180 to 210 and FIG. 10B shows those in the 20 range of 420 to 46°.

Note that the patterns of LiCoO₂(O3) and CoO₂(O1) are made from crystal structure data obtained from ICSD (see Non-Patent Document 6) with Reflex Powder Diffraction, which is a module of Materials Studio (BIOVIA). The pattern of the H1-3 type structure is similarly made from the crystal structure data disclosed in Non-Patent Document 3. The patterns of the O3′ type structure and the monoclinic O1(15) type structure are obtained in the following manner: the crystal structures are estimated from the XRD pattern of the positive electrode active material 100 of one embodiment of the present invention and fitting is performed with TOPAS ver. 3 (crystal structure analysis software produced by Bruker Corporation).

As shown in FIG. 8 and FIGS. 10A and 10B, the O3′ type structure exhibits diffraction peaks at 2θ of 19.25±0.12° (greater than or equal to 19.130 and less than 19.37°) and 2θ of 45.47±0.100 (greater than or equal to 45.370 and less than 45.57°).

The monoclinic O1(15) type structure exhibits diffraction peaks at 2θ of 19.47±0.10° (greater than or equal to 19.37° and less than or equal to 19.57⁰) and 2θ of 45.62±0.05° (greater than or equal to 45.57° and less than or equal to 45.67⁰).

However, as shown in FIG. 9 and FIGS. 10A and 10B, the H1-3 type structure and the trigonal O1 type structure do not exhibit peaks at these positions. Thus, exhibiting the peak at 20 of greater than or equal to 19.13° and less than 19.37° and/or the peak at 2θ of greater than or equal to 19.37° and less than or equal to 19.57° and the peak at 2θ of greater than or equal to 45.37° and less than 45.57° and/or the peak at 2θ of greater than or equal to 45.57° and less than or equal to 45.67° in a state with small x in LiₓCoO₂ can be the feature of the positive electrode active material 100 of one embodiment of the present invention.

It can be said that the position of an XRD diffraction peak exhibited by the crystal structure with x of 1 is close to that of an XRD diffraction peak exhibited by the crystal structure with x of 0.24 or less. More specifically, it can be said that in the 2θ range of 42° to 46⁰, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 100 of one embodiment of the present invention has the O3′ type structure and/or the monoclinic O1(15) type structure when x in LiₓCoO₂ is small, not all the particles necessarily have the O3′ type structure and/or the monoclinic O1(15) type structure. Some of the particles may have another crystal structure or be amorphous. Note that when the XRD patterns are subjected to the Rietveld analysis, the O3′ type structure and/or the monoclinic O1(15) type structure preferably account for greater than or equal to 50%, further preferably greater than or equal to 60%, still further preferably greater than or equal to 66% of the positive electrode active material. The positive electrode active material in which the O3′ type structure and/or the monoclinic O1(15) type structure account for greater than or equal to 50%, preferably greater than or equal to 60%, further preferably greater than or equal to 66% enables sufficiently good cycle performance.

Furthermore, even after 100 or more cycles of charging and discharging after the measurement starts, the O3′ type structure and/or the monoclinic O1(15) type structure preferably account for greater than or equal to 35%, further preferably greater than or equal to 40%, still further preferably greater than or equal to 43%, in the Rietveld analysis.

In addition, the H1-3 type structure and the O1 type structure account for preferably less than or equal to 50%, further preferably less than or equal to 34%, in the Rietveld analysis performed in a similar manner. It is still further preferable that substantially no H1-3 type structure and substantially no O1 type structure be observed.

Sharpness of a diffraction peak in an XRD pattern indicates the degree of crystallinity. It is thus preferable that the diffraction peaks after charging be sharp or in other words, have a small half width, e.g., a small full width at half maximum. Even peaks that are derived from the same crystal phase have different half widths depending on the XRD measurement conditions and the 2θ value. In the case of the above-described measurement conditions, the peak observed in the 2θ range of 43° to 46° preferably has a full width at half maximum less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity efficiently contributes to stability of the crystal structure after charging.

The crystallite size of the O3′ type structure and the monoclinic O1(15) type structure of the positive electrode active material 100 is decreased to approximately 1/20 of that of LiCoO₂ (O3) in a discharged state. Thus, the peak of the O3′ type structure and/or the peak of the monoclinic O1(15) type structure can be clearly observed when x in LiₓCoO₂ is small even under the same XRD measurement conditions as those of a positive electrode before charging and discharging. By contrast, conventional LiCoO₂ has a small crystallite size and exhibits a broad and small peak although it can partly have a structure similar to the O3′ type structure and/or the monoclinic O1(15) type structure. The crystallite size can be calculated from the half width of the XRD peak.

As described above, the influence of the Jahn-Teller effect is preferably small in the positive electrode active material 100 of one embodiment of the present invention. The positive electrode active material 100 of one embodiment of the present invention may contain a transition metal such as nickel or manganese as the additive element in addition to cobalt as long as the influence of the Jahn-Teller effect is small.

The proportions of nickel and manganese and the range of the lattice constants with which the influence of the Jahn-Teller effect is presumed to be small in the positive electrode active material are examined by XRD analysis.

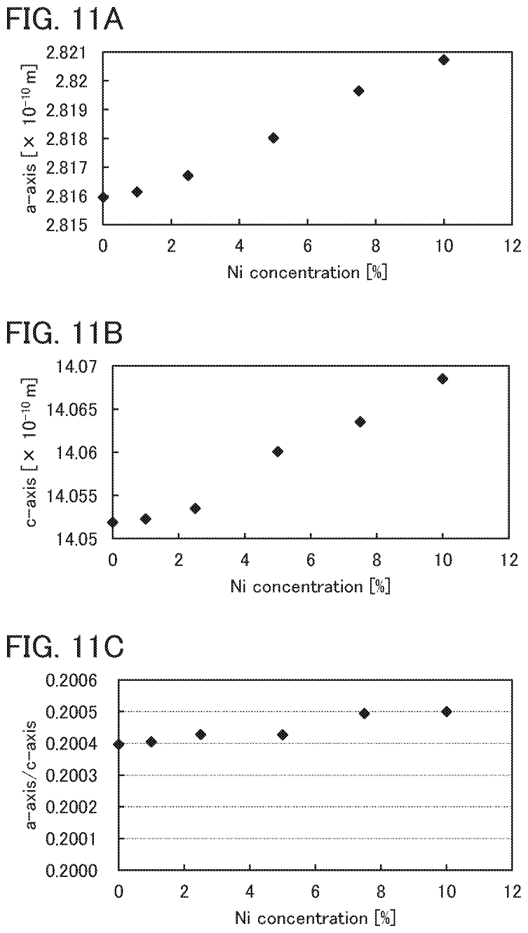

FIGS. 11A to 11C show the calculation results of the lattice constants of the a-axis and the c-axis by XRD in the case where the positive electrode active material 100 of one embodiment of the present invention has a layered rock-salt crystal structure and contains cobalt and nickel. FIG. 11A shows the results of the a-axis, and FIG. 11B shows the results of the c-axis. Note that the XRD patterns of powder after the synthesis of the positive electrode active material before incorporation into a positive electrode were used for the calculation. The nickel concentration on the horizontal axis represents a nickel concentration with the sum of the number of cobalt atoms and the number of nickel atoms regarded as 100%.

FIG. 11C shows values obtained by dividing the lattice constants of the a-axis by the lattice constants of the c-axis (a-axis/c-axis) in the positive electrode active material, whose results of the lattice constants are shown in FIGS. 11A and 111B.

As shown in FIG. 11C, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. It is suggested that an excellent positive electrode active material with small Jahn-Teller distortion can be obtained at a nickel concentration lower than 7.5%.

Note that the nickel concentration in the surface portion 100a is not limited to the above range. In other words, the nickel concentration in the surface portion 100a may be higher than the above concentration.

Preferable ranges of the lattice constants of the positive electrode active material of one embodiment of the present invention are examined above. In the layered rock-salt crystal structure of the positive electrode active material 100 in a discharged state or a state where charging and discharging are not performed, which can be estimated from the XRD patterns, the lattice constant of the a-axis is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charging and discharging are not performed may be the state of powder before the formation of a positive electrode of a secondary battery.

Alternatively, in the layered rock-salt crystal structure of the positive electrode active material 100 in a discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in a discharged state or the state where charging and discharging are not performed is subjected to XRD analysis, a first peak is observed in the 2θ range of 18.50° to 19.30° and a second peak is observed in the 2θ range of 38.00° to 38.80°, in some cases.

### {XPS}

In an inorganic oxide, a region that extends from the surface to a depth of approximately 2 nm to 8 nm (normally, less than or equal to 5 nm) can be analyzed by XPS using monochromatic aluminum Kα radiation as an X-ray source; thus, the concentrations of elements in a region extending to approximately half the depth of the surface portion 100a can be quantitatively analyzed by XPS. The bonding states of the elements can be analyzed by narrow scanning. The quantitative accuracy of XPS is about ±1 atomic % in many cases. The lower detection limit is about 1 atomic %, depending on the element.

In the XPS analysis, monochromatic aluminum Kα radiation can be used as an X-ray source, for example. An extraction angle is, for example, 45°. For example, Quantera II (ULVAC-PHI, Inc.) can be used as a measurement apparatus.

When XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms. When the atomic ratio is within the above range, it can be said that the additive element is not attached to the surface of the positive electrode active material 100 in a narrow range but widely distributed at a preferable concentration in the surface portion 100a of the positive electrode active material 100.

When the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This value is different from the bonding energy of lithium fluoride (685 eV) and that of magnesium fluoride (686 eV).

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride (1305 eV) and is close to that of magnesium oxide.

### {EDX and EELS}

One or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using an FIB or the like and analyzing the cross section using EDX, EELS, EPMA, or the like.

EDX measurement and EELS measurement for two-dimensional evaluation of an area by area scan are referred to as EDX area analysis and EELS area analysis. EDX measurement and EELS measurement for evaluation of the atomic concentration distribution in a positive electrode active material by line scan are referred to as EDX line analysis and EELS line analysis. Furthermore, extracting data of a linear region from EDX area analysis or EELS area analysis is referred to as EDX line analysis or EELS line analysis in some cases. The measurement of a region without scanning is referred to as point analysis.

By area analysis (e.g., element mapping), the concentrations of the additive element in the surface portion 100a, the inner portion 100b, the vicinity of the crystal grain boundary 101, and the like of the positive electrode active material 100 can be quantitatively analyzed. By line analysis, the concentration distribution and the highest concentration of the additive element can be analyzed. An analysis method in which a thinned sample is used is preferred because the method makes it possible to analyze the concentration distribution in the depth direction from the surface toward the center in a specific region of the positive electrode active material regardless of the distribution in the front-back direction.

Area analysis or point analysis of the positive electrode active material 100 of one embodiment of the present invention preferably reveals that the concentration of each additive element, especially the concentration of the additive element Xin the surface portion 100a is higher than that in the inner portion 100b.

According to results of the line analysis, where the surface of the positive electrode active material 100 is can be estimated in the following manner. A point where the detected amount of an element which is uniformly present in the inner portion 100b of the positive electrode active material 100, e.g., oxygen or cobalt, is ½ of the detected amount thereof in the inner portion 100b can be assumed as the surface.

Since the positive electrode active material 100 is a composite oxide, the detected amount of oxygen can be used to estimate where the surface is. Specifically, an average value Oₐᵥₑ of the oxygen concentration of a region of the inner portion 100b where the detected amount of oxygen is stable is calculated first. At this time, in the case where oxygen O_{bg} which is probably led from chemical adsorption or the background is detected in a region that is obviously outside the surface, O_{bg} is subtracted from the measurement value to obtain the average value Oₐᵥₑ of the oxygen concentration. The measurement point where the measurement value which is closest to ½ of the average value Oₐᵥₑ is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is unlikely to be affected by chemical adsorption and is thus suitable for the estimation of where the surface is.

### [Additional Features]

The positive electrode active material 100 has a depression, a crack, a concave, a V-shaped cross section, or the like in some cases. These are examples of defects, and when charging and discharging are repeated, elution of cobalt, breakage of a crystal structure, cracking of the positive electrode active material 100, release of oxygen, or the like might be derived from these defects. However, when there is the filling portion 102 as in FIG. 3B that fills such defects, elution of cobalt or the like can be inhibited. Thus, the positive electrode active material 100 can have excellent reliability and excellent cycle performance.

As described above, an excessive amount of the additive element in the positive electrode active material 100 might adversely affect insertion and extraction of lithium ions. The use of such a positive electrode active material 100 for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting deterioration of a crystal structure. The additive element is required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the inner portion 100b of the positive electrode active material 100, so that the additive element concentration can be appropriate in the inner portion 100b. This can inhibit an internal resistance increase, a charge and discharge capacity decrease, and the like when the positive electrode active material 100 is used for a secondary battery. A feature of inhibiting an internal resistance increase in a secondary battery is extremely preferable especially in charging and discharging with a large amount of current such as charging and discharging at 400 mA/g or more.

In the positive electrode active material 100 including the region where the additive element is unevenly distributed, addition of excess additive elements to some extent in the formation process is acceptable. This is preferable because the margin of production can be increased.

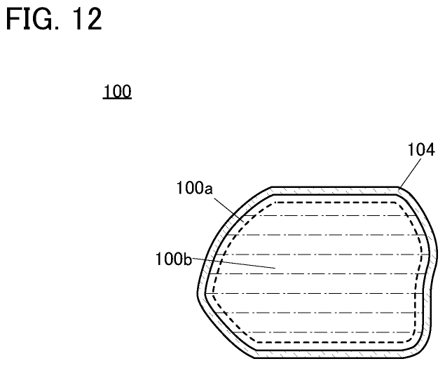

A coating portion may be attached to at least part of the surface of the positive electrode active material 100. FIG. 12 illustrates an example of the positive electrode active material 100 to which a coating portion 104 is attached. In FIG. 12, the coating portion 104 is provided to cover the surface portion 100a. In the case where an uneven portion, a crack, or the filling portion 102 shown in FIG. 3B is formed in the surface of the positive electrode active material 100, the coating portion 104 may be provided to cover the uneven portion, the crack, or the filling portion 102.

The coating portion 104 is preferably formed by deposition of decomposition products of a lithium salt, an organic electrolyte solution, and the like due to charging and discharging, for example. A coating portion originating from an organic electrolyte solution, which is formed on the surface of the positive electrode active material 100, is expected to improve charge and discharge cycle performance particularly when charging that makes x in LiₓCoO₂ be 0.24 or less is repeated. This is because an increase in impedance of the surface of the positive electrode active material is inhibited or elution of cobalt is inhibited, for example. The coating portion 104 preferably contains carbon, oxygen, and fluorine, for example. The coating portion can have high quality easily when the electrolyte solution includes LiBOB and/or suberonitrile (SUN), for example. Accordingly, the coating portion 104 preferably contains one or more selected from boron, nitrogen, sulfur, and fluorine to possibly have high quality. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100. In a portion without the coating portion 104, fluorine may be adsorbed onto the surface of the positive electrode active material 100.

At least part of this embodiment can be implemented in combination with any of the other embodiments described in this specification, as appropriate.

### Embodiment 2

In this embodiment, an example of a method for forming the positive electrode active material 100 which is one embodiment of the present invention is described.

A way of adding an additive element is important in forming the positive electrode active material 100 described in the above embodiment. Favorable crystallinity of the inner portion 100b is also important.

In the formation process of the positive electrode active material 100 using one method, lithium cobalt oxide is synthesized first, an additive element source is then mixed, and heat treatment is performed. In a different method, an additive element source may be mixed together with a cobalt source and a lithium source to synthesize lithium cobalt oxide containing the additive element. It is preferable that heating be performed in addition to mixing of lithium cobalt oxide and the additive element source to make the additive element be dissolved in lithium cobalt oxide. Sufficient heating is preferably performed to enable favorable distribution of the additive element. The heat treatment after the mixing of the additive element source is thus important. The heat treatment after the mixing of the additive element source may be referred to as baking or annealing.

However, heating at an excessively high temperature may cause cation mixing, which increases the possibility of entry of the additive element such as magnesium into the cobalt sites. Magnesium that is present at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed as the additive element or together with the additive element source. As the fusing agent, a substance having a lower melting point than lithium cobalt oxide can be used. For example, a fluorine compound such as lithium fluoride is preferably used as a fusing agent. Addition of a fusing agent lowers the melting points of the additive element source and lithium cobalt oxide. Lowering the melting points makes it easier to distribute the additive element favorably at a temperature at which cation mixing is less likely to occur.

### [Initial Heating]

It is further preferable that heat treatment be performed between the synthesis of lithium cobalt oxide and the mixing of the additive element. This heating is referred to as initial heating in some cases. Since lithium ions are extracted from part of the surface portion 100a of lithium cobalt oxide by the initial heating, the distribution of the additive element becomes more favorable.

Specifically, the distributions of the additive elements can be easily made different from each other by the initial heating in the following mechanism. First, lithium ions are extracted from part of the surface portion 100a by the initial heating. Next, additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed. Note that this phase is formed in part of the surface portion 100a, and thus is sometimes not clearly observed in an image obtained with an electron microscope, such as a STEM image, and an electron diffraction pattern.

Among the additive elements, nickel is likely to be dissolved and is diffused to the inner portion 100b in the case where the surface portion 100a is lithium cobalt oxide having a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

In consideration of the ion radius, aluminum is considered to be present at a site other than a lithium site more stably in a layered rock-salt crystal structure than in a rock-salt crystal structure. Thus, in the surface portion 100a, aluminum is more likely to be distributed in, than in a region having a rock-salt phase that is close to the surface, a region having a layered rock-salt phase at a position deeper than the region and/or the inner portion 100b.

Moreover, the initial heating is expected to increase the crystallinity of the layered rock-salt crystal structure of the inner portion 100b. For this reason, the initial heating is particularly preferably performed in order to form the positive electrode active material 100 that has the monoclinic O1(15) type structure when x in LiₓCoO₂ is, for example, greater than or equal to 0.15 and less than or equal to 0.17.

However, the initial heating is not necessarily performed. In some cases, by controlling atmosphere, temperature, time, or the like in another heating step, the positive electrode active material 100 that has the O3′ type structure and/or the monoclinic O1(15) type structure when x in LiₓCoO₂ is small can be formed.

### [Formation Method 1 of Positive Electrode Active Material]

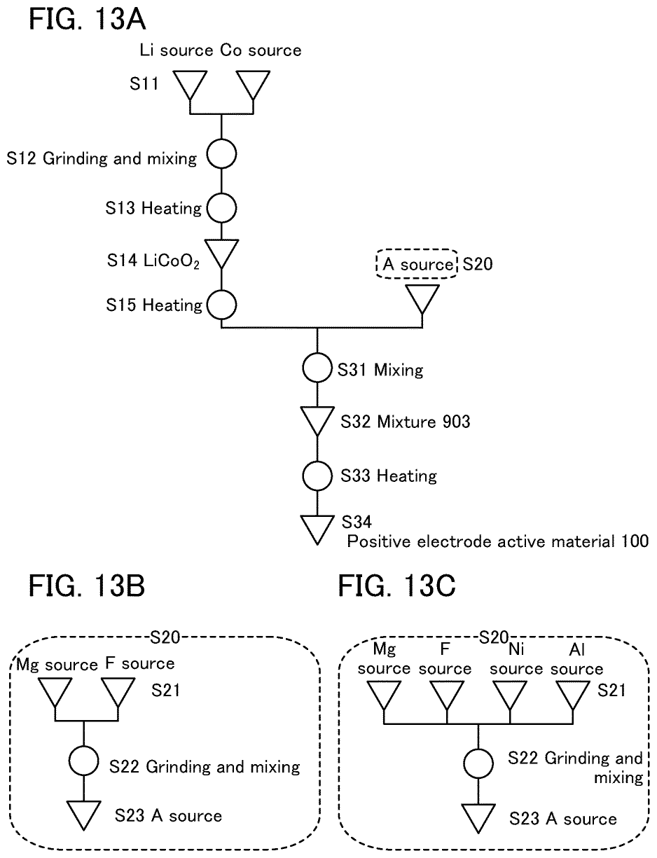

A formation method 1 of the positive electrode active material 100, in which the initial heating is performed, is described with reference to FIGS. 13A to 13C.

### <Step S11>

In Step S11 shown in FIG. 13A, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used and for example, cobalt oxide (typically, tricobalt tetraoxide), cobalt hydroxide, or the like can be used.

The cobalt source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with increased capacity and/or increased reliability can be obtained.

Furthermore, the cobalt source preferably has high crystallinity and for example, the cobalt source preferably includes single crystal grains. The crystallinity of the cobalt source can be evaluated with a TEM image, an STEM image, a HAADF-STEM image, or an ABF-STEM image or by XRD, electron diffraction, neutron diffraction, or the like. Note that the above methods for evaluating crystallinity can also be employed to evaluate the crystallinity of materials other than the cobalt source.

### <Step S12>

Next, in Step S12 shown in FIG. 13A, the lithium source and the cobalt source are ground and mixed to form a mixed material. The grinding and mixing can be performed by a dry method or a wet method. A wet method is preferred because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% in the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the grinding and mixing are performed at a peripheral speed of 838 mm/s (the number of rotations: 400 rpm, the ball mill diameter: 40 mm).

### <Step S13>

Next, in Step S13 shown in FIG. 13A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to one hour and shorter than or equal to 100 hours, further preferably longer than or equal to two hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, flowing is not necessarily performed. For example, a method may be employed in which the pressure in the reaction chamber is reduced, the reaction chamber is filled (or “purged”) with oxygen, and the exit of the oxygen from the reaction chamber is prevented. For example, the pressure in the reaction chamber may be reduced to −970 hPa with reference to the atmospheric pressure and then, the reaction chamber may be filled with oxygen until the pressure becomes 50 hPa.

Although cooling after the heating can be performed by letting the mixed material stand to cool, the cooling is preferably performed as gradually as possible (also referred to as “gradual cooling”). In consideration of the productivity, the time it takes for the temperature to decrease to room temperature from a predetermined temperature is preferably longer than or equal to 10 hours and shorter than or equal to 50 hours. The maximum temperature falling rate at the time of the cooling can be controlled to fall within, for example, higher than or equal to 80° C./h and lower than or equal to 250° C./h, preferably higher than or equal to 180° C./h and lower than or equal to 210° C./h. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible used at the time of the heating is preferably made of aluminum oxide. An aluminum oxide crucible is made of a material that hardly releases impurities. In this embodiment, a crucible made of aluminum oxide with a purity of 99.9% is used. The heating is preferably performed with the crucible covered with a lid, in which case volatilization or sublimation of a material can be prevented. A lid at least prevents volatilization or sublimation of a material at the time when the temperature is raised and lowered in this step, and does not necessarily seal off a crucible. For example, this step can be performed without sealing off the crucible in the case where the reaction chamber is filled with oxygen as described above.

If an unused crucible is used, some materials such as lithium fluoride might be absorbed by, diffused in, transferred to, and/or attached to a saggar in the heating and the composition of the formed positive electrode active material is deviated from a designed value in some cases. Thus, it is preferable to use a crucible that has been subjected to a heating step at least once, preferably twice or more in the state where materials containing lithium, the transition metal M, and/or the additive element are placed in the crucible.

The heated material is ground as needed and may be made to pass through a sieve. Before collection of the heated material, the material may be moved from the crucible to a mortar. As the mortar, a zirconium oxide mortar can be suitably used. A zirconium oxide mortar is made of a material that hardly releases impurities. Specifically, a mortar made of zirconium oxide with a purity higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 13A. In the case where a median diameter (D50) is employed as the particle diameter of lithium cobalt oxide, lithium cobalt oxide is preferably ground in order that the positive electrode active material 100 with a relatively small median diameter (D50) can be obtained.

Although the example is described in which the composite oxide is formed by a solid phase method as in Steps S11 to S14, the composite oxide may be formed by a coprecipitation method. Alternatively, the composite oxide may be formed by a hydrothermal method.

### <Step S15>

Next, as Step S15 shown in FIG. 13A, lithium cobalt oxide is heated. The heating in Step S15 is the first heating performed on lithium cobalt oxide and thus, this heating is sometimes referred to as the initial heating. The heating is performed before Step S20 described below and thus is sometimes referred to as preheating or pretreatment. The crucible, lid, and/or the like used in this step are/is similar to those used in Step S13. Although the initial heating is expected to have the following effects, the initial heating is optional in obtaining the positive electrode active material of one embodiment of the present invention.

By the initial heating, an effect of increasing the crystallinity of the inner portion 100b can be expected. The lithium source and/or cobalt source prepared in Step S11 and the like might contain impurities. The initial heating can reduce impurities in lithium cobalt oxide obtained in Step S14.

Furthermore, through the initial heating, the surface of lithium cobalt oxide becomes smooth. Having a smooth surface refers to a state where the composite oxide has little unevenness and is rounded as a whole and its corner portion is rounded. A smooth surface refers to a surface to which few foreign substances are attached. Foreign substances are deemed to cause unevenness and are preferably not attached to a surface.

For the initial heating, a lithium source is not needed. Alternatively, an additive element source is not needed. Alternatively, a material functioning as a fusing agent is not needed.

When the heating time in this step is too short, an efficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature higher than or equal to 700° C. and lower than or equal to 1000° C. for longer than or equal to two hours and shorter than or equal to 20 hours.

In some cases, distortion of the surface and the inner portion of lithium cobalt oxide is reduced by performing the heating in Step S15, reducing the inner stress. Thus, shift, slip, or the like in a crystal is expected to be less likely to occur. Furthermore, when deformation due to stress in the manufacturing process is less likely to occur, a step is less likely to be generated in the surface, making the surface of a composite oxide to be formed smooth in some cases. In a secondary battery including lithium cobalt oxide with a smooth surface as a positive electrode active material, deterioration by charging and discharging is suppressed and cracking of the positive electrode active material can be prevented.

Note that pre-synthesized lithium cobalt oxide may be used in Step S14. In this case, Steps S11 to S13 can be skipped. When Step S15 is performed on the pre-synthesized lithium cobalt oxide, lithium cobalt oxide with a smooth surface can be obtained.

### <Step S20>

Next, as shown in Step S20, the additive element A is preferably added to lithium cobalt oxide that has been subjected to the initial heating. When the additive element A is added to lithium cobalt oxide that has been subjected to the initial heating, the additive element A can be uniformly added. It is thus preferable that the initial heating precede the addition of the additive element A. The step of adding the additive element A is described with reference to FIGS. 13B and 13C.

### <Step S21>

In Step S21 shown in FIG. 13B, an additive element A source (A source) to be added to lithium cobalt oxide is prepared. A lithium source may be prepared in addition to the additive element A source.

As the additive element A, the additive element described in the above embodiment, for example, either the additive element X or the additive element Y can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or both of bromine and beryllium can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride (LiF) and magnesium fluoride (MgF₂) are mixed at a molar ratio of approximately 65:35, the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, “an approximate value of a given value” means a value greater than 0.9 times and less than 1.1 times the given value.

### <Step S22>

Next, in Step S22 shown in FIG. 13B, the magnesium source and the fluorine source are ground and mixed. Any of the conditions for the grinding and mixing that are described for Step S12 can be selected to perform Step S22.

### <Step S23>

Next, in Step S23 shown in FIG. 13B, the materials ground and mixed in the above step are collected to give the additive element A source (A source). Note that the additive element A source in Step S23 contains a plurality of starting materials and can be referred to as a mixture.

As for the particle diameter of the mixture, its median diameter (D50) is preferably greater than or equal to 600 nm and less than or equal to 10 μm, further preferably greater than or equal to 1 μm and less than or equal to 5 μm. Also when one kind of material is used as the additive element source, the median diameter (D50) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of a lithium cobalt oxide particle uniformly in a later step of mixing with lithium cobalt oxide. The mixture is preferably attached uniformly to the surface of lithium cobalt oxide particle, in which case the additive element is easily distributed or dispersed uniformly in the surface portion 100a of the composite oxide after heating.

### <Step S21>

A process different from that in FIG. 13B is described with reference to FIG. 13C. In Step S21 shown in FIG. 13C, four kinds of additive element sources to be added to lithium cobalt oxide are prepared. In other words, FIG. 13C is different from FIG. 13B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 13B. As the nickel source, nickel oxide, nickel hydroxide, or the like can be used. As the aluminum source, aluminum oxide, aluminum hydroxide, or the like can be used.

### <Steps S22 and S23>

Step S22 and Step S23 shown in FIG. 13C are similar to the steps described with reference to FIG. 13B.

### <Step S31>

Next, in Step S31 shown in FIG. 13A, lithium cobalt oxide and the additive element A source (A source) are mixed. The ratio of the number of cobalt (Co) atoms in lithium cobalt oxide to the number of magnesium (Mg) atoms in the additive element A source (Co:Mg) is preferably 100:y (0.1≤y≤6), further preferably 100:y (0.3≤y 3).

The mixing in Step S31 is preferably performed under milder conditions than the mixing in Step S12, in order not to damage the shapes of lithium cobalt oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for one hour. The mixing is performed in a dry room the dew point of which is higher than or equal to −100° C. and lower than or equal to −10° C.

### <Step S32>

Next, in Step S32 in FIG. 13A, the materials mixed in the above step are collected, whereby a mixture 903 is obtained.

Note that although FIGS. 13A to 13C show the formation method in which the addition of the additive element is performed after the initial heating, the present invention is not limited to the above-described method. The addition of the additive element may be performed at another timing or may be performed a plurality of times. The timing of the addition may be different between the additive elements.

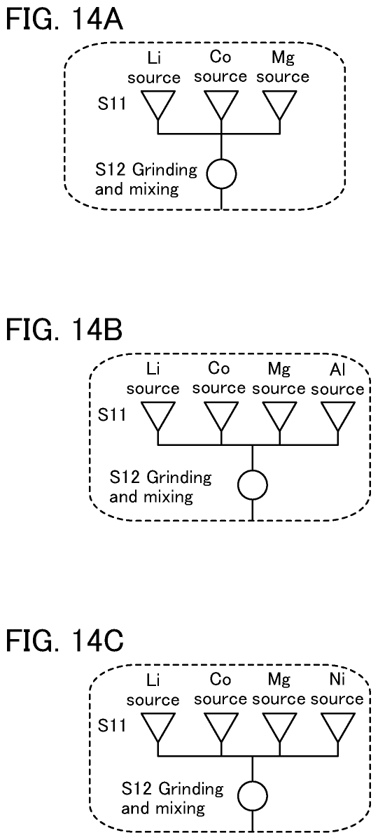

For example, the additive element may be added to the lithium source and the cobalt source in Step S11, i.e., at the stage of the starting materials of the composite oxide, as shown in FIGS. 14A to 14C. FIG. 14A shows a process of adding the magnesium source to the lithium source and the cobalt source. FIG. 14B shows a process of adding the magnesium source and the aluminum source to the lithium source and the cobalt source. FIG. 14C shows a process of adding the magnesium source and the nickel source to the lithium source and the cobalt source. The additive element sources shown in FIGS. 14A to 14C are merely examples.

The process is followed by Step S12, and lithium cobalt oxide containing the additive element can be obtained in Step S13. The distribution of the additive element can be controlled by changing the timing of the addition of the additive element. The additive element added as shown in any of FIGS. 14A to 14C is expected to be located in the inner portion of the positive electrode active material 100. Steps S21 to S23 described above do not need to be performed separately from Steps S11 to S14 described above in the case where any of the processes shown in FIGS. 14A to 14C is employed, so that the method is simplified and enables increased productivity. Needless to say, another additive element may be added in Step S20 also in the case where any of the processes shown in FIGS. 14A to 14C is employed.

Alternatively, lithium cobalt oxide that contains some of the additive elements in advance may be used. When lithium cobalt oxide to which magnesium and fluorine are added is used, for example, part of the processes in Steps S11 to S14 and Step S20 can be skipped, so that the method is simplified and enables increased productivity.

Alternatively, after the heating in Step S15, to lithium cobalt oxide to which magnesium and fluorine are added in advance, a magnesium source and a fluorine source, or a magnesium source, a fluorine source, a nickel source, and an aluminum source may be added as in Step S20.

### <Step S33>

Then, in Step S33 shown in FIG. 13A, the mixture 903 is heated. Any of the heating conditions described for Step S13 can be selected for this heating. The heating time is preferably longer than or equal to two hours. Here, the pressure in a furnace may be higher than atmospheric pressure to make the oxygen partial pressure of the heating atmosphere high. An insufficient oxygen partial pressure of the heating atmosphere might cause reduction of cobalt or the like and prevent lithium cobalt oxide or the like from maintaining a layered rock-salt crystal structure.

Here, a supplementary explanation of the heating temperature is provided. The lower limit of the heating temperature in Step S33 needs to be higher than or equal to the temperature at which a reaction between lithium cobalt oxide and the additive element source proceeds. The temperature at which the reaction proceeds is the temperature at which interdiffusion of the elements included in lithium cobalt oxide and the additive element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 650° C.

Needless to say, the reaction more easily proceeds at a temperature higher than or equal to the temperature at which one or more selected from the materials contained in the mixture 903 are melted. For example, in the case where LiF and MgF₂ are included as the additive element sources, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature in Step S33 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is higher than or equal to 800° C. and lower than or equal to 1100° C., preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C. Note that the heating temperature in Step S33 is preferably lower than that in Step S13.

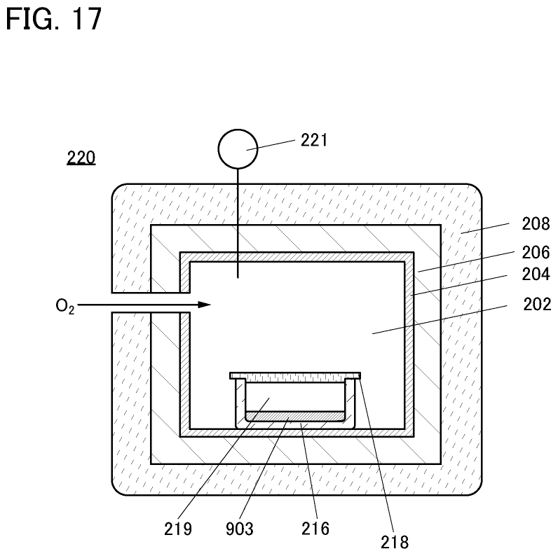

An example of the heating furnace used in Step S33 is described with reference to FIG. 17.

A heating furnace 220 illustrated in FIG. 17 includes a space 202 in the heating furnace, a hot plate 204, a pressure gauge 221, a heater unit 206, and a heat insulator 208. When the heating is performed with a container 216, which corresponds to a crucible or a saggar, covered with a lid 218, the atmosphere in a space 219 enclosed by the container 216 and the lid 218 can contain a fluoride. During the heating, the state of the space 219 is maintained with the lid put on so that the concentration of the gasified fluoride inside the space 219 can be constant or cannot be reduced, in which case fluorine and magnesium can be contained in the vicinity of the particle surface. The atmosphere in the space 219, which is smaller in capacity than the space 202 in the heating furnace, can contain a fluoride through volatilization of a smaller amount of fluoride. This means that the atmosphere in the reaction system can contain a fluoride without a significant reduction in the amount of fluoride included in the mixture 903. Accordingly, LiMO₂ can be produced efficiently. In addition, the use of the lid 218 allows heating of the mixture 903 in an atmosphere containing a fluoride to be simply and inexpensively performed.

Thus, before the heating is performed, the container 216 in which the mixture 903 is placed is placed in the space 202 in the heating furnace and an atmosphere containing oxygen is provided in the space 202 in the heating furnace. The steps in this order enable the mixture 903 to be heated in an atmosphere containing oxygen and a fluoride. For example, flowing of a gas is performed during the heating (flowing). The gas can be introduced from below the space 202 in the heating furnace and exhausted to above the space 202 in the heating furnace. During the heating, the space 202 in the heating furnace may be sealed off to be a closed space so that the gas is not transferred to the outside (purging).

Although there is no particular limitation on a method for providing an atmosphere containing oxygen in the space 202 in the heating furnace, examples of the method include a method in which air is exhausted from the space 202 in the heating furnace and an oxygen gas or a gas containing oxygen such as dry air is then introduced, and a method in which an oxygen gas or a gas containing oxygen such as dry air is fed into the space 202 in the heating furnace for a certain period of time. In particular, introducing an oxygen gas after exhausting air from the space 202 in the heating furnace (oxygen replacement) is preferably performed. Note that the air in the space 202 in the heating furnace may be regarded as an atmosphere containing oxygen.

The fluoride or the like attached to the inner walls of the container 216 and the lid 218 can be fluttered again by the heating to be attached to the mixture 903.

There is no particular limitation on the step of heating the heating furnace 220. The heating may be performed using a heating mechanism included in the heating furnace 220.

Although there is no particular limitation on the way of placing the mixture 903 in the container 216, as illustrated in FIG. 17, the mixture 903 is preferably placed such that the top surface of the mixture 903 is flat with respect to the bottom surface of the container 216, in other words, the level of the top surface of the mixture 903 is uniform.

The heating in Step S33 described above is preferably performed with the pressure in the furnace controlled using the pressure gauge 221. The furnace is preferably in an atmospheric pressure state or a pressurized state. Under pressure, for example, the surface of lithium cobalt oxide is probably melted. That is, the surface of lithium cobalt oxide heated together with LiF and MgF₂ may be melted under pressure.

Although cooling after the heating in Step S33 can be performed by letting the mixture 903 stand to cool, the cooling is preferably performed gradually as in Step S13. The above description of Step S13 can be referred to for preferable ranges of the temperature falling time and the temperature falling rate.

In addition, at the time of heating the mixture 903, the partial pressure of fluorine or a fluorine compound originating from the fluorine source or the like is preferably controlled to be within an appropriate range. The partial pressure may be controlled by performing the heating in this step with the crucible covered with the lid. As described above, the lid can prevent volatilization or sublimation of a material. Thus, at the time when the temperature is raised and lowered in this step, the crucible is not necessarily sealed off with the lid as long as volatilization or sublimation of a material is prevented. For example, this step can be performed without sealing off the crucible in the case where the reaction chamber in which the crucible is put is filled with oxygen. A positive electrode active material containing fluorine or a fluorine compound in an appropriate manner is preferable because the positive electrode active material would inhibit ignition and smoking if an internal short circuit occurs.

In the formation method described in this embodiment, some of the materials, e.g., LiF as the fluorine source, function as a fusing agent in some cases. Owing to the material functioning as a fusing agent, the heating temperature can be lower than the decomposition temperature of lithium cobalt oxide, e.g., higher than or equal to 742° C. and lower than or equal to 950° C., which allows distribution of the additive element such as magnesium in the surface portion and formation of a positive electrode active material having favorable characteristics.

However, since LiF in a gas phase has a specific gravity less than that of oxygen, the heating might volatilize or sublimate LiF. In the case where LiF is volatilized, LiF in the mixture 903 decreases. As a result, the function of a fusing agent is degraded. Therefore, the heating needs to be performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluorine compound having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903. The crucible is preferably covered with the lid so that volatilization of LiF is inhibited.

The heating in this step is preferably performed such that the particles of the mixture 903 are not adhered to each other. Adhesion of the particles of the mixture 903 during the heating might decrease the area of contact with oxygen in the atmosphere and block a path of diffusion of the additive element (e.g., fluorine), thereby hindering distribution of the additive element (e.g., magnesium and fluorine) in the surface portion. In order that a reaction with oxygen in the atmosphere can be promoted, the heating may be performed with the crucible not sealed off with the lid.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container in which the mixture 903 is put covered with a lid in a manner similar to that of the crucible covered with the lid.

A supplementary explanation of the heating time is provided. The heating time depends on conditions such as the heating temperature and the particle size and composition of lithium cobalt oxide in Step S14. The heating may be preferably performed at a lower temperature or for a shorter time in the case where the particle size of lithium cobalt oxide is small than in the case where the particle size is large.

In the case where lithium cobalt oxide in Step S14 in FIG. 13A has a median diameter (D50) of approximately 12 μm, the heating temperature is preferably higher than or equal to 650° C. and lower than or equal to 950° C., for example. The heating time is preferably longer than or equal to three hours and shorter than or equal to 60 hours, further preferably longer than or equal to 10 hours and shorter than or equal to 30 hours, still further preferably approximately 20 hours, for example. Note that the time for lowering the temperature after the heating is preferably longer than or equal to 10 hours and shorter than or equal to 50 hours, for example.

In the case where lithium cobalt oxide in Step S14 has a median diameter (D50) of approximately 5 μm, the heating temperature is preferably higher than or equal to 650° C. and lower than or equal to 950° C., for example. The heating time is preferably longer than or equal to one hour and shorter than or equal to 10 hours, further preferably approximately five hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 13A, in which crushing is performed as needed; thus, the positive electrode active material 100 is obtained. Through the above process, the positive electrode active material 100 of one embodiment of the present invention can be formed. The positive electrode active material of one embodiment of the present invention has a smooth surface.

### [Formation Method 2 of Positive Electrode Active Material]

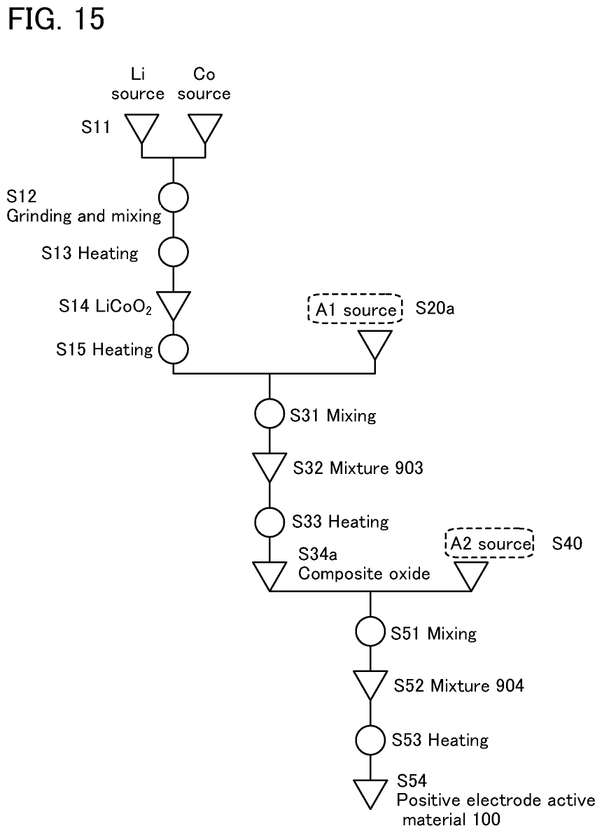

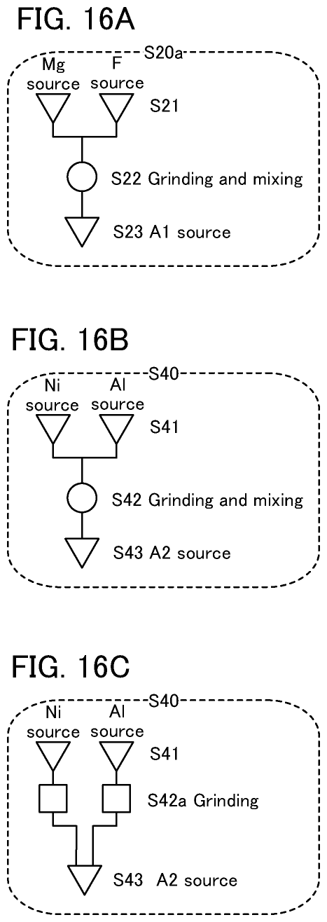

Next, as one embodiment of the present invention, a formation method 2 of a positive electrode active material, which is different from the formation method 1 of a positive electrode active material, is described with reference to FIG. 15 and FIG. 16A to 16C. The formation method 2 of a positive electrode active material is different from the formation method 1 mainly in the number of times of adding the additive element and a mixing method. For the description except for the above, the description of the formation method 1 of a positive electrode active material can be referred to.

Steps S11 to S15 in FIG. 15 are performed as in FIG. 13A to prepare lithium cobalt oxide that has been subjected to the initial heating.

### <Step S20a>

Next, as shown in Step S20a, an additive element A1 is preferably added to lithium cobalt oxide that has been subjected to the initial heating.

### <Step S21>

In Step S21 shown in FIG. 16A, a first additive element source is prepared. For the first additive element source, any of the examples of the additive element A described for Step S21 with reference to FIG. 13B can be used. For example, one or more elements selected from magnesium, fluorine, and calcium can be suitably used as the additive element A1. FIG. 16A shows an example of using a magnesium source (Mg source) and a fluorine source (F source) as the first additive element source.

Steps S21 to S23 shown in FIG. 16A can be performed under conditions similar to those of Steps S21 to S23 shown in FIG. 13B, whereby the additive element source (Al source) can be obtained in Step S23.

Steps S31 to S33 shown in FIG. 15 can be performed in a manner similar to that of Steps S31 to S33 shown in FIG. 13A.

### <Step S34a>

Next, the material heated in Step S33 is collected to give lithium cobalt oxide containing the additive element A1. This composite oxide is called a second composite oxide to be distinguished from the composite oxide in Step S14.

### <Step S40>

In Step S40 shown in FIG. 15, an additive element A2 is added. FIGS. 16B and 16C are referred to in the following description.

### <Step S41>

In Step S41 shown in FIG. 16B, a second additive element source is prepared. For the second additive element source, any of the examples of the additive element A described for Step S21 with reference to FIG. 13B can be used. For example, one or more elements selected from nickel, titanium, boron, zirconium, and aluminum can be suitably used as the additive element A2. FIG. 16B shows an example of using a nickel source (Ni source) and an aluminum source (Al source) as the second additive element source.

Steps S41 to S43 shown in FIG. 16B can be performed under conditions similar to those of Steps S21 to S23 shown in FIG. 13B, whereby the additive element source (A2 source) can be obtained in Step S43.

FIG. 16C shows a modification example of the steps described with reference to FIG. 16B. A nickel source (Ni source) and an aluminum source (Al source) are prepared in Step S41 shown in FIG. 16C and are separately ground in Step S42a. Accordingly, a plurality of second additive element sources (A2 sources) are prepared in Step S43. FIG. 16C is different from FIG. 16B in separately grinding the additive elements in Step S42a.

### <Steps S51 to S53>

Next, Steps S51 to S53 shown in FIG. 15 can be performed under conditions similar to those of Steps S31 to S34 shown in FIG. 13A. The heating in Step S53 can be performed at a lower temperature and for a shorter time than the heating in Step S33. Through the above process, the positive electrode active material 100 of one embodiment of the present invention can be formed in Step S54. The positive electrode active material of one embodiment of the present invention has a smooth surface.

As shown in FIG. 15 and FIGS. 16A to 16C, in the formation method 2, introduction of the additive elements to lithium cobalt oxide is separated into introduction of the additive element A1 and that of the additive element A2. When the elements are separately introduced, the additive elements can have different profiles in the depth direction. For example, the additive element A1 can have a profile such that the concentration is higher in the surface portion than in the inner portion, and the additive element A2 can have a profile such that the concentration is higher in the inner portion than in the surface portion.

The initial heating described in this embodiment makes it possible to obtain a positive electrode active material having a smooth surface.

The initial heating described in this embodiment is performed on lithium cobalt oxide. Thus, the initial heating is preferably performed at a temperature lower than the heating temperature for forming lithium cobalt oxide and for a time shorter than the heating time for forming lithium cobalt oxide. The additive element is preferably added to lithium cobalt oxide after the initial heating. The adding step may be separated into two or more steps. Such an order of steps is preferred in order to maintain the smoothness of the surface achieved by the initial heating.

The positive electrode active material 100, whose surface is smooth, may be less likely to be physically broken by pressure application or the like than a positive electrode active material whose surface is not smooth. For example, the positive electrode active material 100 is unlikely to be broken in a test involving pressure application such as a nail penetration test, meaning that the positive electrode active material 100 has high safety.

At least part of this embodiment can be implemented in combination with any of the other embodiments described in this specification, as appropriate.

### Embodiment 3

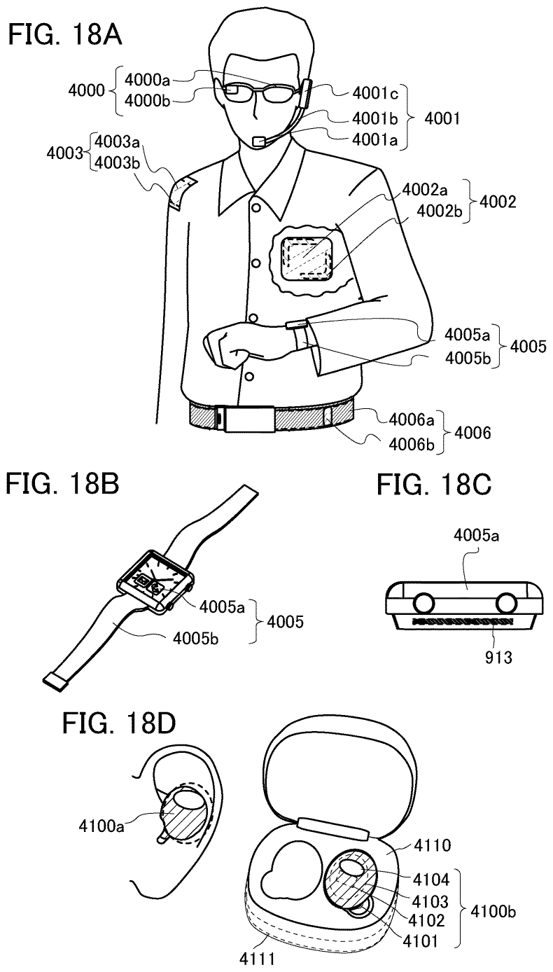

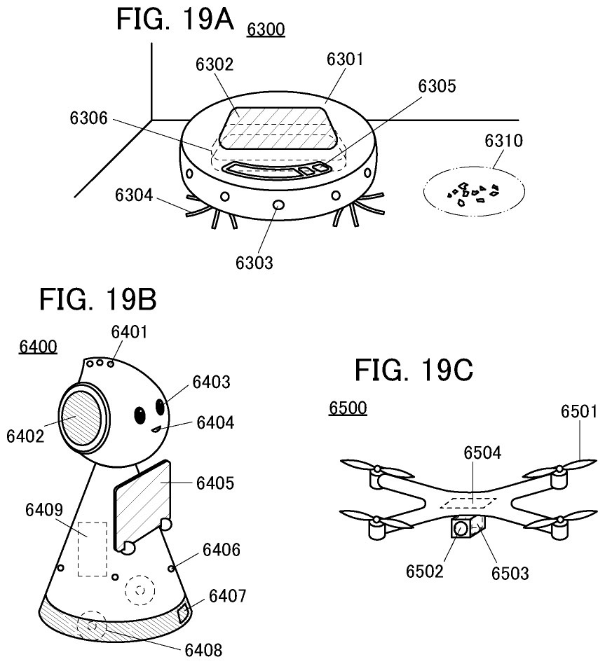

In this embodiment, examples of electronic devices each including the secondary battery described in the above embodiment are described with reference to FIGS. 18A to 18D and FIGS. 19A to 19C.

FIG. 18A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 18A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 18B is a perspective view of the watch-type device 4005 that is detached from an arm.

FIG. 18C is a side view. FIG. 18C illustrates a state where the secondary battery 913 is incorporated in the watch-type device 4005. The secondary battery 913, which is small and lightweight, overlaps with the display portion 4005a.

FIG. 18D illustrates an example of wireless earphones. The wireless earphones shown as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charge, and the like. Each of the earphone bodies 4100a and 4100b may also include a microphone.

A case 4110 includes a secondary battery 4111. Moreover, the case 4110 preferably include a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 19A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 19B illustrates an example of a robot. A robot 6400 illustrated in FIG. 19B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 19C illustrates an example of a flying object. A flying object 6500 illustrated in FIG. 19C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

Next, examples of vehicles each including the secondary battery of one embodiment of the present invention are described.

The use of secondary batteries in vehicles enables production of next-generation clean energy vehicles such as hybrid vehicles (HV), electric vehicles (EV), and plug-in hybrid vehicles (PHV).

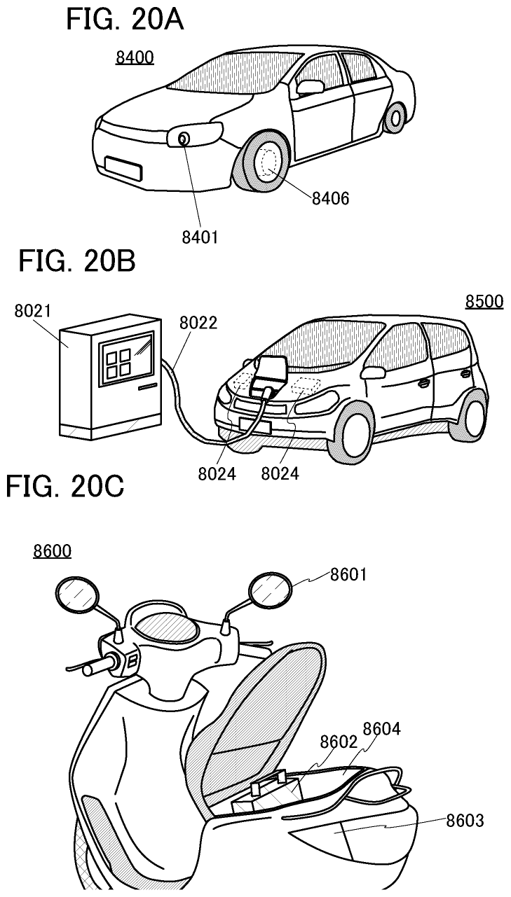

FIGS. 20A to 20C each illustrate an example of a vehicle using the secondary battery of one embodiment of the present invention. An automobile 8400 illustrated in FIG. 20A is an electric vehicle that runs on the power of an electric motor. Alternatively, the automobile 8400 is a hybrid electric vehicle capable of driving using either an electric motor or an engine as appropriate. The use of one embodiment of the present invention allows fabrication of a high-mileage vehicle. The automobile 8400 includes the secondary battery. As the secondary battery, modules of secondary batteries may be arranged to be used in a floor portion in the automobile. Alternatively, a battery pack in which a plurality of secondary batteries are combined may be placed in the floor portion in the automobile. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 20B illustrates an automobile 8500 including the secondary battery. The automobile 8500 can be charged when the secondary battery is supplied with electric power from external charging equipment by a plug-in system and/or a contactless power feeding system, for example. In FIG. 20B, a secondary battery 8024 included in the automobile 8500 is charged with the use of a ground-based charging apparatus 8021 through a cable 8022. In charging, a given method such as CHAdeMO (registered trademark) or Combined Charging System can be employed as a charging method, the standard of a connector, or the like as appropriate. The charging apparatus 8021 may be a charging station provided in a commerce facility or a power source in a house. For example, with the use of a plug-in technique, the secondary battery 8024 included in the automobile 8500 can be charged by being supplied with electric power from outside. The charging can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 20C shows an example of a motorcycle using the secondary battery of one embodiment of the present invention. A motor scooter 8600 illustrated in FIG. 20C includes a secondary battery 8602, side mirrors 8601, and indicators 8603. The secondary battery 8602 can supply electric power to the indicators 8603.

Furthermore, in the motor scooter 8600 illustrated in FIG. 20C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle and thereby increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

At least part of this embodiment can be implemented in combination with any of the other embodiments described in this specification, as appropriate.

### Example 1

In this example, a positive electrode active material of one embodiment of the present invention was formed, and results of analyzing the composition in a surface portion of the positive electrode active material are described.

### [Formation of Positive Electrode Active Material]

In this example, a positive electrode active material was formed by the formation method shown in FIG. 15 and FIGS. 16A to 16C.

As LiCoO₂ in Step S14 in FIG. 15, lithium cobalt oxide (Cellseed C-10N produced by NIPPON CHEMICAL INDUSTRIAL CO., LTD.) was prepared. The initial heating in Step S15 was performed on lithium cobalt oxide, which was put in a crucible covered with a lid, in a muffle furnace at 850° C. for two hours. No flowing was performed after the muffle furnace was filled with an oxygen atmosphere (O₂ purging).

In accordance with Step S21 shown in FIG. 16A, LiF and MgF₂ were prepared as the F source and the Mg source, respectively. LiF and MgF₂ were weighed so that LiF:MgF₂=1:3 (molar ratio). Then, LiF and MgF₂ were mixed into dehydrated acetone and the mixture was stirred at a rotational speed of 400 rpm for 12 hours, whereby an additive element source (Al source) was produced. In the mixing, a ball mill was used and a grinding medium was zirconium oxide balls. The capacity of the container of the mixing ball mill was 45 mL, and lithium cobalt oxide, LiF, and MgF₂ weighing approximately 9 g in total were mixed together with 20 mL of dehydrated acetone and 22 g of zirconium oxide balls (1 mm 4). Then, the mixture was made to pass through a sieve with an aperture of 300 μm, whereby the Al source was obtained.

Next, as Step S31, the A1 source was weighed to be 1 mol % with respect to lithium cobalt oxide, and mixed with lithium cobalt oxide subjected to the initial heating by a dry method. Stirring was performed for one hour at a rotational speed of 150 rpm, which is milder condition than stirring performed for obtaining the A1 source. Finally, the mixture was made to pass through a sieve with an aperture of 300 μm, whereby the mixture 903 having a uniform particle diameter was obtained (Step S32).

Subsequently, in Step S33, the mixture 903 was heated. The heating was performed at 900° C. for 20 hours. During the heating, the mixture 903 was in a crucible covered with a lid. The crucible was filled with an atmosphere containing oxygen and entry and exit of the oxygen were blocked (purged). By the heating, a composite oxide containing Mg and F was obtained (Step S34a).

Then, in Step S51, the composite oxide and the additive element source (the A2 source) were mixed. Nickel hydroxide on which a grinding step was performed was prepared as the nickel source and aluminum hydroxide on which a grinding step was performed was prepared as the aluminum source in accordance with Step S41 shown in FIG. 16C. Nickel hydroxide and aluminum hydroxide were each weighed to be 0.5 mol % with respect to lithium cobalt oxide, and were mixed with the composite oxide by a dry method. Stirring was performed at a rotational speed of 150 rpm for one hour. In the mixing, a ball mill was used and a grinding medium was zirconium oxide balls. The capacity of the container of the mixing ball mill was 45 mL, and the composite oxide, the nickel source, and the aluminum source weighing approximately 7.5 g in total were mixed together with 22 g of zirconium oxide balls (1 mm φ). These conditions were milder than those of the stirring in the production of the A1 source. Finally, the mixture was made to pass through a sieve with an aperture of 300 μm, whereby a mixture 904 was obtained (Step S52).

Finally, in Step S53, the mixture 904 was heated. The heating was performed at 850° C. for 10 hours. During the heating, the mixture 904 was in a crucible covered with a lid. The crucible was filled with an atmosphere containing oxygen and entry and exit of the oxygen were blocked (purged). By the heating, lithium cobalt oxide containing Mg, F, Ni, and Al was obtained (Step S54).

Through the above steps, the positive electrode active material was obtained.

### [STEM-EDX Analysis]

STEM-EDX line analysis was performed on the formed positive electrode active material.

For pretreatment of the analysis, thinned samples were prepared by an FIB method. As the samples, Sample 1 obtained by processing part including a surface parallel to the basal plane of a particle, and Sample 2 obtained by processing part including a surface parallel to a plane intersecting with the basal plane (i.e., the edge plane) of the same particle were prepared.

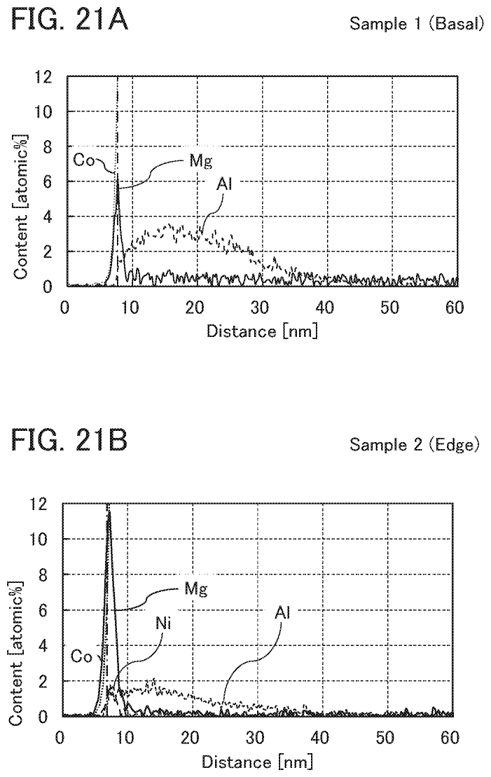

FIGS. 21A and 21B show profiles of STEM-EDX line analysis of Sample 1 and Sample 2. Here, the content of each element was calculated from the profile of the detection intensity obtained by STEM-EDX. The horizontal axis represents detection distance [nm], and the vertical axis represents the content of an element [atomic %]. The positions of the surfaces of Sample 1 and Sample 2 are estimated to be approximately 7.7 nm and approximately 6.8 nm (indicated by dashed-dotted lines) from the profiles of oxygen detection intensity not shown here. Specifically, the average value Oₐᵥₑ of the oxygen concentration was calculated from a region of the inner portion where the detected amount of oxygen (a region that is 20 nm or more in depth) is stable, and a value of a distance corresponding to Oₐᵥ/2 was estimated as the position of the surface.

As shown in FIG. 21A, Mg and Al were detected as the additive elements in the portion including the surface parallel to the basal plane. The highest Mg concentration peak appeared in the vicinity of the surface (in a range that is 3 nm or less in depth from the surface), and the maximum Mg concentration was approximately 6.2 atomic %. The Al concentration peak appeared in a deeper portion (in a range that is 25 nm or less in depth from the surface) than the Mg concentration peak, and Al was present in a wide range (in a range that is approximately 45 nm or less in depth from the surface). The maximum Al concentration was approximately 3.5 atomic %. Note that the Ni concentration was below the lower detection limit.

As shown in FIG. 21B, Mg, Al, and Ni were detected as the additive elements in the portion corresponding to the edge plane. The highest Mg concentration peak appeared in the vicinity of the surface (in a range that is approximately 3 nm or less in depth from the surface), and the maximum Mg concentration was approximately 11.5 atomic %. The Al concentration peak appeared in a deeper portion (in a range that is 20 nm or less in depth from the surface) than the Mg concentration peak, and Al was present in a wide range (in a range that is approximately 45 nm or less in depth from the surface). The maximum Al concentration was approximately 2.1 atomic %. The highest Ni concentration peak appeared in the vicinity of the surface like the Mg concentration peak, and the maximum Ni concentration was approximately 1.8 atomic %.

### [STEM-EELS Analysis]

Here, F, which is the additive element, has the energy of the characteristic X-ray which is close to that of Co, and thus is difficult to quantify by EDX. Accordingly, F was evaluated by STEM-EELS analysis. In EELS analysis, not line analysis but point analysis was performed on a plurality of positions at different depths in consideration of damage to the samples.

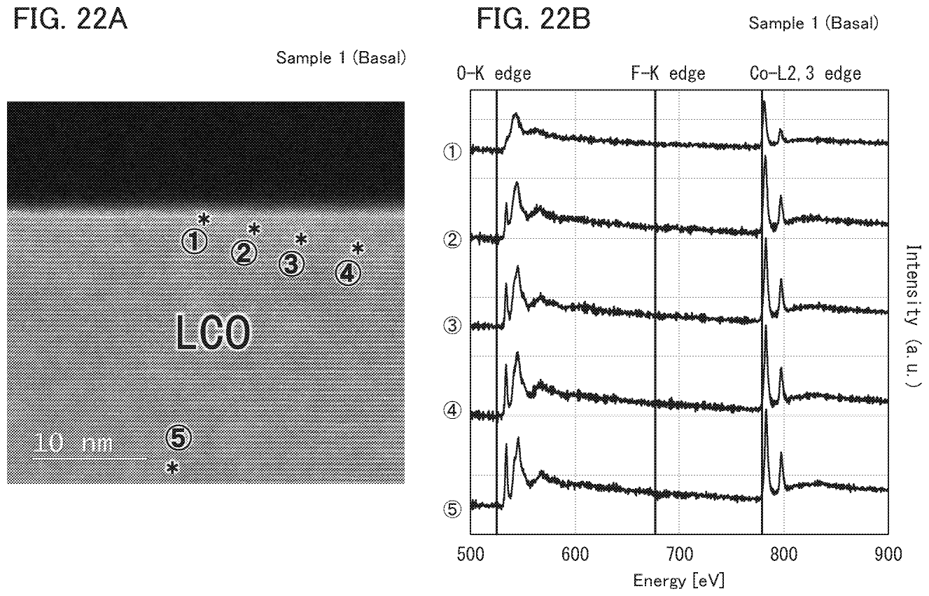

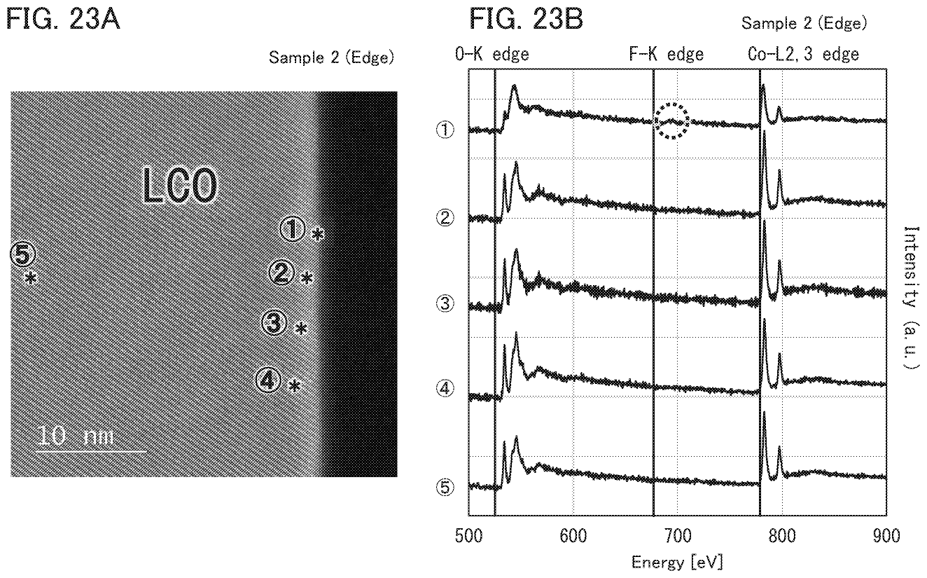

FIG. 22A and FIG. 23A show HAADF-STEM images of Sample 1 and Sample 2, respectively, each including five points subjected to EELS point analysis. Measurement point 1 is the closest to the surface, followed by Measurement points 2, 3, and 4. Measurement point 5 is positioned deeper than the other four points.

FIG. 22B and FIG. 23B show results of STEM-EELS analysis of Sample 1 and Sample 2, respectively. In each graph, the horizontal axis represents energy [eV], and the vertical axis represents intensity (a.u.).

As shown in FIG. 22B, a peak of F (a peak to appear in the vicinity of energy of F-K edge) was not observed at any of the measurement points including Measurement point 1, which is the closest to the surface, in the portion including the surface parallel to the basal plane.

Meanwhile, as indicated by a dashed circle in FIG. 23B, a peak of F was observed at Measurement point 1, which is the closest to the surface, in the portion including the edge plane. The content estimated from this profile was approximately 5.5 atomic %.

The results of the STEM-EDX analysis and the STEM-EELS analysis are summarized in Table 1. F was detected only in the vicinity of the surface of Sample 2. Mg was detected in both samples, and Sample 2 had a higher Mg content. Al was detected in both Sample 1 and Sample 2 at similar concentrations. Ni was not detected in Sample 1, while Ni was slightly detected in Sample 2.

TABLE 1
[atomic %]

| | Sample 1 (Basal) | | Sample 2 (Edge) | |
|---|---|---|---|---|
| Element | EDX | EELS | EDX | EELS |
| F | — | below | — | 5.5 |
| | | detection limit | | |
| Mg | 6.2 | — | 11.5 | — |
| Al | 3.5 | — | 2.1 | — |
| Ni | below | — | 1.8 | — |
| | detection limit | | | |

The above results show that neither F nor Ni is detected in the vicinity of the surface parallel to the basal plane. The results also show that F and Ni are detected in the vicinity of the edge plane at higher concentrations than the Mg concentration, and that Al is detected both in the vicinity of the surface parallel to the basal plane and in the vicinity of the edge plane at similar concentrations.

At least part of this example can be implemented in combination with any of the other example and embodiments described in this specification as appropriate.

### Example 2

In this example, calculation was performed with a focus on diffusibility of Ni, which is the additive element, in different surfaces of the positive electrode active material, and a result thereof is described.

In the calculation, LiCoO₂ (denoted by LCO) and Ni(OH)₂ were put in a lower portion and an upper portion, respectively, of the system. The classical molecular dynamics method was used for the calculation. The calculation was performed under the following conditions: the ensemble was NVT, the temperature of the system was 1800 K, and the time was up to and including 200 psec. For the interatomic potential, UFF was used. The potentials of Li, Co, and O were optimized with the crystal structure of LCO, and the potential of Ni was optimized with the crystal structure of NiO.

The calculation was performed on two models: a model assuming that the (003) plane of the surface of LCO is the basal plane, and a model assuming that the (104) plane is the edge plane. The number of atoms in the system was approximately 1500 in the former model and approximately 2200 in the latter model, and the charge of the system was neutral.

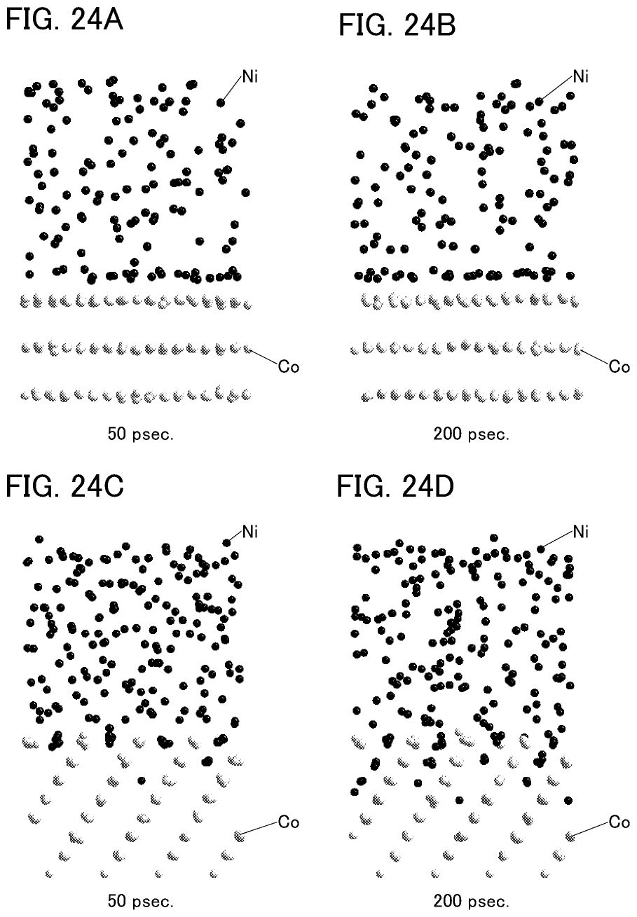

FIGS. 24A and 24B show calculation results for a surface having a (003) orientation and the vicinity of the surface. FIG. 24A shows the result of calculation in which the elapsed time was 50 psec., and FIG. 24B shows the result of calculation in which the elapsed time was 200 psec. In FIGS. 24A and 24B, Ni atoms remain in the surface of LCO and are not diffused into the inner portion.

FIGS. 24C and 24D show calculation results for a surface having a (104) orientation and the vicinity of the surface. In FIGS. 24C and 24D, it is confirmed that Ni atoms are diffused into the inner portion along arranged cobalt atoms.

From the above calculation results, it is confirmed that Ni is difficult to diffuse from the surface parallel to the basal plane of lithium cobalt oxide into the inner portion and easy to diffuse from the edge plane into the inner portion. These results are consistent with the fact that Ni was not detected in the portion including the surface parallel to the basal plane and Ni was detected in the portion including the edge plane in Example 1.

At least part of this example can be implemented in combination with any of the other example and embodiments described in this specification as appropriate.

This application is based on Japanese Patent Application Serial No. 2022-121785 filed with Japan Patent Office on Jul. 29, 2022, the entire contents of which are hereby incorporated by reference.

What is claimed is:

1. A method for manufacturing a positive electrode active material, comprising:
heating a first composite oxide comprising lithium and cobalt;
forming a first mixture by mixing the heated first composite oxide comprising lithium and cobalt, a first material comprising lithium and fluorine, and a second material comprising magnesium and fluorine;
heating the first mixture to form a second composite oxide comprising lithium, cobalt, magnesium, and fluorine;
forming a second mixture by mixing a third material comprising nickel, a fourth material comprising aluminum, and the second composite oxide comprising lithium, cobalt, magnesium, and fluorine; and
heating the second mixture,
wherein the heating of the first composite oxide comprising lithium and cobalt is performed under a condition in which the first composite oxide comprising lithium and cobalt is placed in a crucible covered with a lid,
wherein the heating of the first mixture is performed under a condition in which the first mixture is placed in a crucible covered with a lid, and
wherein the heating of the second mixture is performed under a condition in which the second mixture is placed in a crucible covered with a lid.

2. The method according to claim 1,
wherein the heating of the first composite oxide comprising lithium and cobalt is performed at a temperature higher than pr equal to 700° C. an lower than or equal to 1000° C. for longer than or equal to 2 hours and shorter than or equal to 20 hours.
